(19) United States
(12) Patent Application Publication
(10) Pub. No.: US 2013/0114575 A1
(43) Pub. Date: May 9, 2013

(54) METHOD FOR TRANSMITTING HARQ-ACK FEEDBACK INFORMATION

(71) Applicant: Samsung Electronics Co. Ltd., Suwon-si (KR)

(72) Inventors: Jingxing FU, Beijing (CN); Zheng ZHAO, Beijing (CN); Chengjun SUN, Beijing (CN)

(73) Assignee: SAMSUNG ELECTRONICS CO. LTD., Suwon-si (KR)

(21) Appl. No.: 13/667,548

(22) Filed: Nov. 2, 2012

(30) Foreign Application Priority Data
Nov. 4, 2011 (CN) 201110349243.2
Dec. 27, 2011 (CN) 201110443553.0
Apr. 9, 2012 (CN) 201210102090.6

(51) Int. Cl. H04W 72/04; H04J 3/00

(52) U.S. Cl. 370/336

(57) ABSTRACT

A method for transmitting Hybrid Automatic Repeat reQuest-ACKnowledgement (HARQ-ACK) feedback information is provided. The method includes obtaining HARQ-ACK feedback information, a total number of bits of which is less than or equal to four through performing group bundling on the HARQ-ACK feedback information of all sub-frames in a current HARQ-ACK bundling window of two Component Carriers (CCs), determining a number of Physical Uplink Control Channel (PUCCH) resources provided for transmission of the HARQ-ACK feedback information according to data transmission modes of the two CCs, and a number of elements in the bundling window, and transmitting the HARQ-ACK feedback information after the group bundling to a base station on PUCCH channel resources adopting a PUCCH format 1b of channel selection according to the PUCCH channel resources mapped from the HARQ-ACK feedback information after the group bundling and modulation symbols.

### PRIORITY

This application claims the benefit under 35 U.S.C. §119(a) of a Chinese patent application filed on Nov. 4, 2011 in the State Intellectual Property Office (SIPO) of the People's Republic of China and assigned Serial No. 201110349243.2, a Chinese patent application filed on Dec. 27, 2011 in the SIPO and assigned Serial No. 201110443553.0, and a Chinese patent application filed on Apr. 9, 2012 in the SIPO and assigned Serial No. 201210102090.6, the entire disclosure of each of which is hereby incorporated by reference.

### BACKGROUND OF THE INVENTION

1. Field of the Invention

The present invention relates to radio communication system technologies. More particularly, the present invention relates to a method for transmitting Hybrid Automatic Repeat reQuest-ACKnowledgement (HARQ-ACK) feedback information.

2. Description of the Related Art

The Long-Term Evolution (LTE) system supports two duplex modes, i.e., Frequency Division Duplex (FDD) and Time Division Duplex (TDD).

FIG. 1 is a schematic diagram illustrating a frame structure of a TDD system according to the related art.

Referring to FIG. 1, each radio frame has a length of 10 ms and is divided into two half frames with the length of 5 ms. Each half frame includes eight timeslots, each of which has a length of 0.5 ms and three special domains, i.e., a Downlink Pilot Timeslot (DwPTS), a Guard Period (GP), and an Uplink Pilot Timeslot (UpPTS). The total length of the three special domains is 1 ms. Each sub-frame consists of two consecutive timeslots. For example, the k-th sub-frame consists of timeslot 2k and timeslot 2k+1. The TDD system supports seven different UpLink/DownLink (UL/DL) configurations. As shown in Table 1, “D” represents a DL sub-frame, “U” represents a UL sub-frame, and “S” represents a special sub-frame which includes the above three special domains.

TABLE 1
UL/DL configurations of the LTE TDD

| Config- | Conversion | | | | | | | | | | |
|---|---|---|---|---|---|---|---|---|---|---|---|
| uration | point | Sub-frame number | | | | | | | | | |
| number | period | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 10 ms | D | S | U | U | U | D | S | U | U | D |

In order to enhance the transmission rate of the user, an LTE-Advanced (LTE-A) system of the LTE system is put forward. In the LTE-A, larger work bandwidth is obtained by aggregating multiple Component Carriers (CCs), i.e., the Carrier Aggregation (CA) to form the DL and UL of the communication system and to support higher transmission rate. For instance, in order to support 100 MHz bandwidth, the bandwidth may be obtained by aggregating five 20 MHz CCs. Here, each CC is referred to as a cell. As for a User Equipment (UE), the base station may be configured to work in multiple CCs. One is the Primary CC (PCC or Pcell), and the other CCs are referred to as Secondary CCs (SCCs or Scells).

The LTE-A TDD system prescribes that multiple CCs which aggregate together adopt the same UL/DL configurations.

FIG. 2 is a chart illustrating UL/DL configurations of each CC in a same CA according to the related art.

Referring to FIG. 2, the CA includes 2 CCs, which are the PCC and SCC. Both the PCC and the SCC adopt the TDD UL/DL configuration 1. According to a method of the related art, both the PCC and SCC comply with the same Hybrid Automatic Repeat reQuest-ACKnowledgement (HARQ-ACK) timing relationship. Sub-frames 0 and 1 of the PCC and sub-frames 0 and 1 of the SCC feed back the HARQ-ACK feedback information in sub-frame 8 of the PCC. Here, if both the PCC and SCC adopt the Single Input Multiple Output (SIMO) transmission mode. The HARQ-ACK feedback information of the PCC is two bits and the HARQ-ACK feedback information of the SCC is two bits.

Table 2 lists the bits of the HARQ-ACK feedback information and Physical Uplink Control Channel (PUCCH) resources. “HARQ-ACK(0)˜HARQ-ACK (3)” respectively represents bits one through three of the HARQ-ACK feedback information. As shown in Table 2, HARQ-ACK (0) and HARQ-ACK (1) belong to the PCC and is the HAQR-ACK feedback information of relevant sub-frames of the PCC. HARQ-ACK (2) and HARQ-ACK (3) belong to the SCC, and is the HAQR-ACK feedback information of relevant sub-frames of the SCC. In addition, the PCC and SCC respectively map out two HARQ-ACK resources.

TABLE 2

| | HARQ-ACK(j) | | | |
|---|---|---|---|---|
| | HARQ- | HARQ- | HARQ- | HARQ- |
| A | ACK(0) | ACK(1) | ACK(2) | ACK(3) |
| 4 | The first | The second | The first | The second |
| | sub-frame of | sub-frame of | sub-frame of | sub-frame of |
| | the PCC | the PCC | the SCC | the SCC |

When the frequency domain distances among multiple CCs executing the CA are large enough, these CCs can adopt different UL/DL configurations without interfering with each other. In addition, in some cases, the adjacent channel of each CC has been deployed with different UL/DL configurations (for instance, the adjacent channel is deployed with different Time Division-Synchronous Code Division Multiple Access (TD-SCDMA) configurations). Thereafter, if the same UL/DL configurations are deployed for these CCs, severe adjacent channel interferences will occur. Therefore, in the subsequent research of the LTE-A, an urgent task is studying how to transmit the HARQ-ACK feedback information when the UL/DL configurations of multiple CCs executing the CA are different.

According to the current discussion result, a timing relationship of the HARQ-ACK information corresponding to a Physical Downlink Shared Channel (PDSCH) sent on the Pcell and a Physical Downlink Control Channel (PDCCH) denoting the Semi-Persistent Scheduling (SPS) release adopts a timing relationship of the TDD UL/DL configurations of the Pcell. For example, the processing method is the same as that of the UE and is only configured with one cell. For the Scell, if non cross-carrier scheduling is adopted, for each combination of the TDD UL/DL configurations of the Pcell and Scell, the timing relationship of the HARQ-ACK corresponding to the PDSCH of the Scell works according to the following Table Y-1.

TABLE Y-1

| | | UL/DL configurations of Pcell | | | | | | |
|---|---|---|---|---|---|---|---|---|
| HARQ timing of Scell | | 0 | 1 | 2 | 3 | 4 | 5 | 6 |
| UL/DL | 0 | — | 1 | 2 | 3 | 4 | 5 | 6 |
| configurations | 1 | 1 | — | 2 | 4 | 4 | 5 | 1 |
| of Scell | 2 | 2 | 2 | — | 5 | 5 | 5 | 2 |
| | 3 | 3 | 4 | 5 | — | 4 | 5 | 3 |
| | 4 | 4 | 4 | 5 | 4 | — | 5 | 4 |
| | 5 | 5 | 5 | 5 | 5 | 5 | — | 5 |
| | 6 | 6 | 1 | 2 | 3 | 4 | 5 | — |

Specifically, for the situation that a set consisting of DL sub-frames of the Scell is a sub-set of a set consisting of DL sub-frames of the Pcell, the timing relationship of the HARQ-ACK corresponding to the PDSCH on the Scell is determined according to the timing relationship of the TDD UL/DL configurations of the Pcell.

For the situation that the set consisting of the DL sub-frames of the Scell is a superset of the set consisting of the DL sub-frames of the Pcell, the timing relationship of the HARQ-ACK corresponding to the PDSCH on the Scell is determined according to the timing relationship of the TDD UL/DL configurations of the Scell.

For the situation that a set consisting of the DL sub-frames of the Scell is neither the sub-set nor the superset of the set consisting of the DL sub-frames of the Pcell, the timing relationship of the HARQ-ACK corresponding to the PDSCH on the Scell is determined according to a timing relationship of reference TDD UL/DL configurations. The UL sub-frames in the reference TDD UL/DL configurations belong to an intersection of the UL sub-frames of the Pcell and the UL sub-frames of the Scell.

For the convenience of description, all the TDD UL/DL configurations which are defined by the combinations of the TDD UL/DL configurations of each Pcell and Scell in Table Y-1 and are used for determining the HARQ-ACK timing of the PDSCH of the Scell are referred to as the TDD UL/DL configurations for determining the timing relationship.

For the Scell, if the cross-carrier scheduling is adopted, for the combinations of the TDD UL/DL configurations of each Pcell and Scell, the timing relationship of the HARQ-ACK corresponding to the PDSCH on the Scell is being discussed and is not concluded yet.

Therefore, a need exists for a method for transmitting HARQ-ACK feedback information.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a method for transmitting Hybrid Automatic Repeat reQuest-ACKnowledgement (HARQ-ACK) feedback information.

Another aspect of the present invention is to provide a method for implementing the transmission of the HARQ-ACK feedback information in a situation that Time Division Duplex (TDD) UpLink/DownLink (UL/DL) configurations of two Component Carriers (CCs) of a Carrier Aggregation (CA) are different.

In accordance with an aspect of the present invention, a method for transmitting HARQ-ACK feedback information is provided. The method includes receiving, by a User Equipment (UE), Physical Downlink Shared Channel (PDSCH) data from CCs with different TDD uplink and downlink configurations, and obtaining corresponding HARQ-ACK feedback information, performing, by the UE, group bundling on the HARQ-ACK feedback information of all sub-frames in a current HARQ-ACK bundling window of the two CCs, and obtaining HARQ-ACK feedback information, a total number of bits of which is less than or equals to four, determining, by the UE, a number of Physical Uplink Control Channel (PUCCH) resources provided for transmission of the HARQ-ACK feedback information according to data transmission modes of the two CCs, and a number of elements in the bundling window, transmitting, by the UE, the HARQ-ACK feedback information after the group bundling to a base station on PUCCH channel resources adopting a PUCCH format 1b of channel selection according to the PUCCH resources mapped from the HARQ-ACK feedback information after the group bundling and modulation symbols.

The group bundling may include generating at most two bits of the HARQ-ACK feedback information according to respective bundling window of the two CCs.

The generating of at most two bits of the HARQ-ACK feedback information may include, if a number of bundling window of a CC is one, HARQ-ACK feedback information of the CC being one bit when the CC is configured with Single Input Multiple Output (SIMO) transmission, and the HARQ-ACK feedback information of the CC being two bits when the CC is configured with Multiple Input Multiple Output (MIMO) transmission, if the number of the bundling windows of the CC is two, the HARQ-ACK feedback information of the CC being two bits when the CC is configured with the SIMO transmission, and the HARQ-ACK feedback information being four bits when the CC is configured with the MIMO transmission, performing spatial bundling on the four bits of the HARQ-ACK feedback information to generate two bits of the HARQ-ACK feedback information, if the number of the bundling windows of the CC is larger than two, performing time domain bundling on the HARQ-ACK feedback information of the CC to generate two bits of the HARQ-ACK feedback information when the CC is configured with the SIMO transmission, and performing the spatial bundling on the HARQ-ACK feedback information of the CC first, and performing time domain bundling on the HARQ-ACK feedback information after the spatial bundling to generate two bits of the HARQ-ACK feedback information when the CC is configured with the MIMO transmission.

The exemplary method may further include providing at most two PUCCH format 1a/1b resources for each CC.

The exemplary method for providing at most two PUCCH format 1a/1b resources for each CC may include, if the number of the bundling window of the CC is one, providing one PUCCH format 1a/1b resource which is obtained by an index of a first Control Channel Element (CCE) occupied by a Physical Downlink Control Channel (PDCCH) scheduling the PDSCH or indicated by an ACK/Non-ACK Resource Indicator (ARI) in the PDCCH scheduling the PDSCH for the CC when the CC is configured with the SIMO transmission, and providing two PUCCH format 1a/1b resources which are obtained by the index of the first CCE and an index of a second index occupied by PDCCHs scheduling PDSCHs or indicated by ARIs in the PDCCHs scheduling the PDSCHs for the CC when the CC is configured with the MIMO transmission, if the number of the bundling windows of the CC is two, providing two PUCCH format 1a/1b resources which are obtained by the indexes of the first CCEs occupied by the PDCCHs of sub-frame 0 and sub-frame 1 or indicated by the ARIs in the PDCCHs scheduling the PDSCHs for the CC, and if the number of the bundling windows of the CC is larger than two, providing two PUCCH format 1a/1b resources which are obtained by the indexes of the first CCEs occupied by the PDCCHs, Downlink Allocation Indexes (DAIs) of which are one and two or indicated by the ARIs in the PDCCHs scheduling the PDSCHs for the CC, wherein when a Semi-Persistent Scheduling (SPS) service exists, a PUCCH format 1a/1b resource of semi-static allocation of the SPS service is a first alternative PUCCH format 1a/1b resource, while the index of the first CCE occupied by the PDCCH, the DAI of which is one, is a second alternative PUCCH format 1a/1b resource.

The group bundling may include performing spatial bundling on the HARQ-ACK feedback information of all the sub-frames in the current HARQ-ACK feedback period of the two CCs, if a total number of the bits of the HARQ-ACK feedback information after the spatial bundling equals to four, dividing the HARQ-ACK feedback information after the spatial bundling into two groups to make a total number of bits of the HARQ-ACK feedback information of each group equal to two, if the total number of the bits of the HARQ-ACK feedback information after the spatial bundling is larger than four, dividing the HARQ-ACK feedback information after the spatial bundling into two groups to make each group include at least two bits, performing time domain bundling on the HARQ-ACK feedback information, a total number of bits of which is larger than two after the grouping to make the total number of the bits of the HARQ-ACK feedback information of each group equal to two.

After the spatial bundling and time domain bundling, a number of bits of HARQ-ACK feedback information provided by each CC determines a number of PUCCH format 1a/1b resources provided for each CC, if the number of the bit of the HARQ-ACK feedback information provided by the CC is one, providing one PUCCH format 1a/1b resource which is obtained by an index of a first CCE occupied by a PDCCH scheduling a PDSCH or indicated by an ARI in the PDCCH scheduling the PDSCH for the CC. if the number of the bits of the HARQ-ACK feedback information provided by the CC is two, providing two PUCCH format 1a/1b resources which are obtained by indexes of the first CCEs occupied by PDCCHs, DAIs of which are one and two or indicated by ARIs in PDCCHs scheduling PDSCHs for the CC, if the number of the bits of the HARQ-ACK feedback information provided by the CC is three, providing three PUCCH format 1a/1b resources which are obtained by the indexes of the first CCEs occupied by the PDCCHs, DAIs of which are one, two and three or indicated by the ARIs in the PDCCHs scheduling PDSCHs.

The exemplary method may further include taking, according to an order of number of the sub-frames, HARQ-ACK feedback information of N, which is larger than or equal to one, sub-frames with the maximum number in the current HARQ-ACK feedback period of another CC and the HARQ-ACK feedback information of all the sub-frames of the CC as one group, and taking HARQ-ACK feedback information of the other sub-frames except for the N sub-frames in the current HARQ-ACK feedback period of the another CC as a group, or taking, according to the order of DAIs of the sub-frames, the HARQ-ACK feedback information of M, which is larger than or equal to one, sub-frames with the maximum DAI value in the current HARQ-ACK feedback period of the another CC and the HARQ-ACK feedback information of all the sub-frames of the CC as one group, and taking the HARQ-ACK feedback information of the other sub-frames except for the M sub-frames in the current HARQ-ACK feedback period of the another CC as a group.

The exemplary method may further include taking, according to an order of number of the sub-frames, HARQ-ACK feedback information of N, which is larger than or equal to one, sub-frames with the minimum number in a current HARQ-ACK feedback period of another CC and the HARQ-ACK feedback information of all the sub-frames of the CC as a group, and taking HARQ-ACK feedback information of the other sub-frames except for the N sub-frames in the current HARQ-ACK feedback period of the another CC as a group, or taking, according to the order of DAIs of the sub-frames, the HARQ-ACK feedback information of M, which is larger than or equal to one, sub-frames with the maximum DAI value in the current HARQ-ACK feedback period of another CC and the HARQ-ACK feedback information of all the sub-frames of the CC as one group, and taking the HARQ-ACK feedback information of the other sub-frames except for the M sub-frames in the current HARQ-ACK feedback period of the another CC as a group.

The group bundling may include performing spatial bundling on the HARQ-ACK feedback information of all the sub-frames in the current HARQ-ACK feedback period of the two CCs, wherein if the number of the bundling window of the CC is one, the HARQ-ACK feedback information is one bit, if the number of the bundling windows of the CC is two, two bits of the HARQ-ACK feedback information are generated, and if the number of the bundling windows of the CC is larger than two, time domain bundling is performed on the HARQ-ACK feedback information after spatial bundling to generate two bits of the HARQ-ACK feedback information.

The exemplary method may further include providing at most two PUCCH format 1a/1b resources for each CC.

The exemplary method for providing at most two PUCCH format 1a/1b resources for each CC may include, if the number of the bundling window of the CC is one, providing one PUCCH format 1a/1b resource which is obtained by an index of a first CCE occupied by a PDCCH scheduling the PDSCH or indicated by an ARI in the PDCCH scheduling the PDSCH for the CC, if the number of the bundling windows of the CC is two, providing two PUCCH format 1a/1b resources which are obtained by the indexes of the first CCEs occupied by the PDCCHs of sub-frame 0 and sub-frame 1 or indicated by ARIs in PDCCHs scheduling PDSCHs for the CC, and if the number of the bundling windows of the CC is larger than two, providing two PUCCH format 1a/1b resources which are obtained by the indexes of the first CCEs occupied by the PDCCHs, DAIs of which are one and two or indicated by the ARIs in the PDCCHs scheduling the PDSCHs for the CC, wherein when a SPS service exists, a PUCCH format 1a/1b resource of semi-static allocation of the SPS service is a first alternative PUCCH format 1a/1b resource, while the index of the first CCE occupied by the PDCCH, the DAI of which is one, is the second alternative PUCCH format 1a/1b resource.

The exemplary method may further include performing the time domain bundling on the HARQ-ACK feedback information, the total number of bits of which is larger than two according to an order of number of the sub-frames, or performing the time domain bundling on the HARQ-ACK feedback information, the total number of the bits of which is larger than two according to an order of DAIs of the sub-frames.

A larger value of bundling windows of the two CCs is denoted as M, and HARQ-ACK information of the two CCs is fed back according PUCCH format 1b feedback mapping tables as shown in Table X-1, Table X-2, Table X-3, Table X-4, Table X-5 and Table X-6, wherein the Table X-1 is used for a situation that M equals to one, and sum of bits of HARQ-ACK of the two CCs is two, the Table X-2 is used for a situation that M equals to one, and the sum of the bits of the HARQ-ACK of the two CCs is three, the Table X-3 is used for a situation that M equals to one, and the sum of the bits of the HARQ-ACK of the two CCs is four, the Table X-4 is used for a situation that M equals to two, the Table X-5 is used for a situation that M equals to three, the Table X-6 is used for a situation that M equals to four.

It can be seen from the above exemplary methods that with the method for transmitting the HARQ-ACK feedback information, after performing the group bundling on the collection of the HARQ-ACK feedback information of all the sub-frames of the two CCs in a HARQ-ACK feedback period, the HARQ-ACK feedback information after the group bundling may be transmitted to the base station adopting the PUCCH format 1b of the channel selection according to the PUCCH channel resources mapped from the HARQ-ACK feedback information after the group bundling and modulation symbols. An exemplary embodiment of the present invention implements the correct HARQ-ACK feedback information transmission, and attempts to reduce the influence of the group bundling on the data transmission, optimizes the throughput performance of the data transmission, and further effectively supports the situation the UL/DL configurations of multiple CCs of the CA are different when the TDD UL/DL configurations of the two CCs of the CA are different and under the situation that the HARQ-ACK feedback information of the two CCs is unbalanced.

In the exemplary methods for transmitting the HARQ-ACK feedback information, an improved method for transmitting the HARQ-ACK feedback information is performing the bundling on the HARQ-ACK feedback information of all the DL sub-frames in the HARQ-ACK feedback period of the two CCs, and performing the mapping of the PUCCH channel resources according to the HARQ-ACK feedback information obtained by the bundling. The method has the advantages of low complexity, improved performances and backward compatibility, and will not cause confusion between the base station and terminal when being re-configured.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a schematic diagram illustrating a frame structure of a TDD system according to the related art;

FIG. 2 is a chart illustrating UpLink/DownLink (UL/DL) configurations of each Component Carrier (CC) in a same Carrier Aggregation (CA) according to the related art;

FIG. 3 is a flowchart illustrating a method for transmitting Hybrid Automatic Repeat reQuest-ACKnowledgement (HARQ-ACK) feedback information according to an exemplary embodiment of the present invention;

FIG. 4 is a schematic diagram illustrating a method for transmitting Hybrid Automatic Repeat reQuest-ACKnowledgement (HARQ-ACK) feedback information in a CA according to an exemplary embodiment of the present invention;

FIG. 5 is schematic diagram illustrating a number of bundling windows of two CCs according to a twenty fourth exemplary embodiment of the present invention; and

FIG. 6 is a schematic diagram illustrating a number of bundling windows of two CCs according to a twenty fifth exemplary embodiment of the present invention.

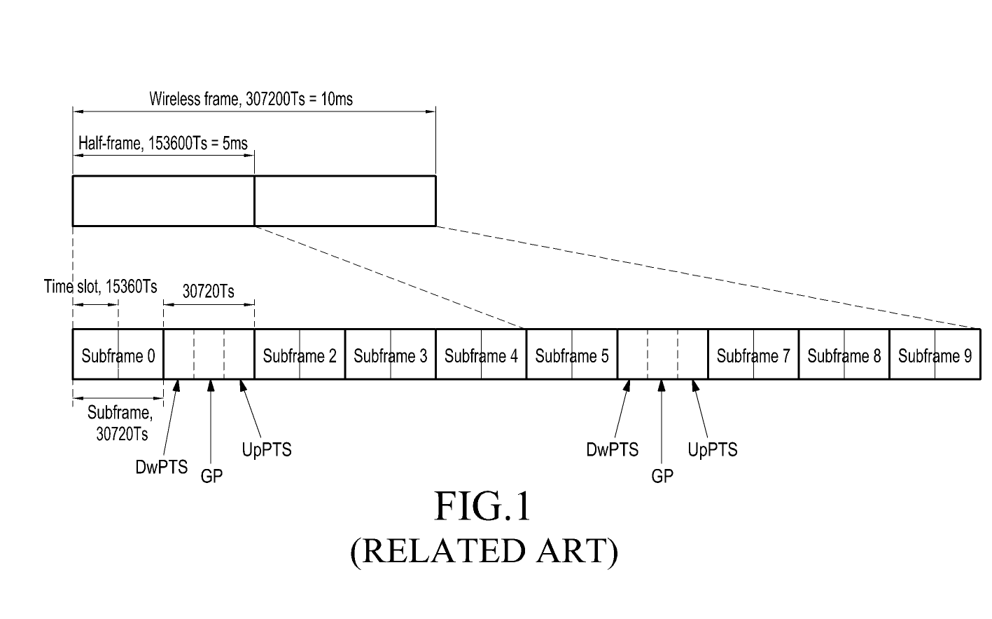

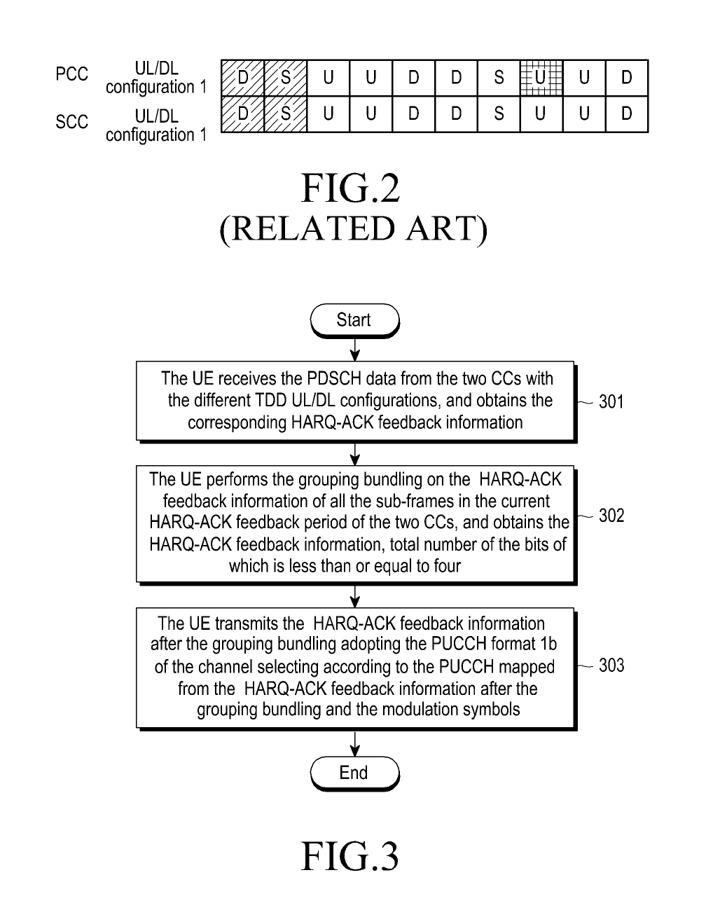

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention are further described hereinafter with reference to the accompanying drawings to make the objective, technical solution and merits thereof more apparent.

In an exemplary embodiment of the present invention, the bundling window mentioned above refers to an aggregation of sub-frames of each Component Carrier (CC) which need to feed back Hybrid Automatic Repeat reQuest-ACKnowledgement (HARQ-ACK) information on sub-frames of a same Primary cell (Pcell) UpLink (UL). Since Time Division Duplex (TDD) UL/DownLink (DL) configurations of the two CCs are different, the bundling windows of the two CCs may be different. For example, the number of the sub-frames included in the bundling windows of the two CCs is different, or timing positions of the sub-frames included in the bundling windows of the two CCs are different.

The exemplary method for determining the bundling window of each CC is described below.

As for a Pcell, the bundling windows corresponding to the UL sub-frames of the Pcell are determined according to the TDD UL/DL configurations of the Pcell.

As for a Secondary cell (Scell), as for all the combinations of the TDD UL/DL configurations of the Pcell and Scell, a bundling window corresponding to the UL sub-frames for transmitting the HARQ-ACK information on the Pcell may be determined according to the TDD UL/DL configurations of the Pcell. One or multiple sub-frames in the bundling window may be the UL sub-frames. In the alternative, as for a UL sub-frame for transmitting the HARQ-ACK information on the Pcell, an aggregation of DL sub-frames which are determined according to the TDD UL/DL configurations of the Pcell and exist on the Scell is defined as an Scell bundling window.

In the alternative, as for the Scell, as for each kind of TDD UL/DL configuration of the Pcell and Scell, a bundling window corresponding to a UL sub-frame for transmitting the HARQ-ACK information on the Pcell may be determined according to the corresponding TDD UL/DL configurations for determining the timing relationship. For instance, when the Scell adopts non cross-carrier scheduling, the TDD UL/DL configurations of the HARQ-ACK timing relationship applied to the Scell in each kind combination of the TDD UL/DL configurations of the Pcell and Scell is determined according to Table Y-1. When the Scell adopts the cross-carrier scheduling, the TDD UL/DL configurations of the HARQ-ACK timing relationship applied to the Scell in each kind combination of the TDD UL/DL configurations of the Pcell and Scell is determined according to provisions of future relevant protocols. One or multiple sub-frames in the bundling window may be the UL sub-frames. In the alternative, as for a UL sub-frame for transmitting the HARQ-ACK information on the Pcell, the aggregation of the DL sub-frames which are determined according to the TDD UL/DL configurations for determining the timing relationship and exist on the Scell is defined as an Scell bundling window.

The exemplary method described below mainly discloses how to process, after determining the bundling window of each CC, the HARQ-ACK feedback information of each CC, i.e., feedback HARQ-ACK bits of a CC, or feed back HARQ-ACK bits which are processed with bundling processing. The exemplary method of the present invention may be applied to the forgoing various methods for defining the bundling window.

FIGS. 3 through 6, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

FIG. 3 is a flowchart illustrating a method for transmitting HARQ-ACK feedback information according to an exemplary embodiment of the present invention.

Referring to FIG. 3, in step 301, a User Equipment (UE) receives Physical Downlink Shared Channel (PDSCH) data from two Component Carriers (CCs) with different TDD UL/DL configurations, decodes the received data, determines whether the data transmission is correct, and obtains corresponding HARQ-ACK feedback information of each sub-frame.

The above HARQ-ACK feedback information may be the ACK, the Non-ACKnowledgement (NACK), or Discontinuous Transmission (DTX) (i.e., the Physical Downlink Control Channel (PDCCH) scheduling the PDSCH is not correctly received, or the corresponding sub-frame is the UL sub-frame).

In this exemplary embodiment of the present invention, the two CCs are respectively recorded as CC0 and CC1. It is assumed that the number of sub-frames in the bundling window of CCi is Mi. For example, the number of the sub-frames in the bundling window of CC0 is M0, while the number of the sub-frames in the bundling window of CC1 is M1.

The HARQ-ACK feedback information of the jth sub-frame (may be referred as sub-frame j) in the bundling window of CCi may be expressed as HARQ-ACK (i, j), wherein i equals to 0 or 1, as for CC0, j equals to 0, . . . , M0-1, as for CC1, j equals to 0, . . . , M1-1. Here, if the jth sub-frame is the UL sub-frame, the feedback information HARQ-ACK (i, j) thereof is the DTX.

If a base station configures CCi as a Single Input Multiple Output (SIMO) transmission mode for transmission, that is, only one codeword of each sub-frame of CCi is transmitted, the HARQ-ACK feedback information HARQ-ACK (i, j) of the jth sub-frame in the bundling window of CCi is expressed with one bit of HARQ-ACK feedback information. The number of bits of the HARQ-ACK feedback information of CCi equals to the number of sub-frames in the bundling window of CCi. The value of HARQ-ACK (i, j) may be {ACK}, {NACK}, or {DTX}.

If the base station configures CCi as a Multiple Input Multiple Output (MIMO) transmission mode for transmission, that is, two codewords of each sub-frame of CCi are transmitted, the HARQ-ACK feedback information HARQ-ACK (i, j) of the jth sub-frame in the bundling window of CCi is the combination of two pieces of HARQ-ACK feedback information, i.e., two bits of HARQ-ACK feedback information. One piece of HARQ-ACK feedback information corresponds to codeword 1 of the MIMO transmission and the other HARQ-ACK feedback information corresponds to codeword 2 of the MIMO transmission. There are Mi combinations of the HARQ-ACK feedback information in the bundling window of CCi. The specific values of HARQ-ACK (i, j) are described below.

If the UE does not correctly decode the PDCCH scheduling the PDSCH, HARQ-ACK (i, j) is a combination of two pieces of DTX information, i.e., {DTX, DTX}.

If the UE correctly decodes the PDCCH scheduling the PDSCH, the possible values of the combinations of the HARQ-ACK feedback information of HARQ-ACK (i, j) may be {ACK, ACK}, {NACK, NACK}, {ACK, NACK} or {NACK, ACK}.

In step 302, the UE bundles the HARQ-ACK feedback information of all the sub-frames in groups. All the sub-frames are in the bundling windows of two CCs of one HARQ-ACK feedback period. The UE obtains bits of the bundled HARQ-ACK feedback information.

In this step, an aggregation of the HARQ-ACK feedback information of all the sub-frames in the bundling windows of the two CCs of one HARQ-ACK feedback period is an aggregation consisting of all the HARQ-ACK feedback information of each sub-frame in the respective bundling window of the two CCs in one HARQ-ACK feedback period.

For instance, it is assumed that in one HARQ-ACK feedback period, the bundling window size of CC0 is one, i.e., only one sub-frame. Moreover, the CC0 adopts the SIMO transmission, and the HARQ-ACK feedback information on the corresponding sub-frame is {ACK}. While the bundling window size of CC1 is 3, the CC1 adopts the MIMO transmission. The HARQ-ACK feedback information of sub-frame zero, first sub-frame, and second sub-frame of the CC1 is {DTX, DTX}, {ACK, ACK}, and {ACK, NACK}, respectively. The aggregation of the HARQ-ACK feedback information of all the sub-frames on the two CCs in the HARQ-ACK period is {ACK, DTX, DTX, ACK, ACK, ACK, NACK}.

The aggregation of the HARQ-ACK feedback information of all the sub-frames is bundled in groups according to a certain principle. All the sub-frames are in the bundling windows of the two CCs in a HARQ-ACK feedback period.

In the first exemplary embodiment of the present invention, the principle of the group bundling is described below.

The grouping is performed in CC, a maximum of two HARQ-ACK bits (or may be referred to as the HARQ-ACK feedback information or HARQ-ACK feedback information bits) is independently generated on each CC according to the respective bundling window of the two CCs, and the bits of HARQ-ACK feedback information of the two CCs are obtained. The UE performs a Physical Uplink Control Channel (PUCCH) format 1b of channel selection transmission according to the HARQ-ACK feedback information bits.

The above exemplary method for independently generating the maximum of two HARQ-ACK bits or the maximum of two pieces of HARQ-ACK feedback information is described below.

If the number of the bundling windows on a CC is one, the time domain bundling and spatial bundling needs not to be performed. When the bundling window adopts the SIMO transmission, only one piece of HARQ-ACK feedback information or one HARQ-ACK feedback information bit is generated. If the MIMO transmission is adopted, two pieces of HARQ-ACK feedback information or two HARQ-ACK feedback information bits are generated.

If the number of the bundling windows on a CC is two, the time domain bundling needs not to be performed. When the CC is configured with the SIMO transmission, two bits of the HARQ-ACK feedback information are obtained. If the CC is configured with the MIMO transmission, the spatial bundling needs to be performed, and two bits of the HARQ-ACK feedback information are generated.

The spatial bundling method is in the 3^{rd} Generation Partnership Project (3GPP) Release-10 (Rel-10) specification. For example, a logic “and” operation is performed on the corresponding HARQ-ACK feedback information corresponding to two codewords in a sub-frame to obtain one piece of HARQ-ACK feedback information or one HARQ-ACK feedback information bit.

If the number of the bundling windows on a certain CC is 2, the time domain bundling needs to be performed. If the CC is configured with the SIMO transmission, two bits of the HARQ-ACK feedback information are obtained through the time domain bundling. If the CC is configured with the MIMO transmission, the spatial bundling needs to be performed first, and the time domain bundling or compression is performed, and two bits of HARQ-ACK feedback information is obtained at last.

According to an exemplary method of the present invention, a time domain bundling or compression method is described below.

As for the situation that the number of the bundling windows is three, the continuous ACK number, is counted based on the sorting of DAIs in an ascending order after which the time domain bundling is performed. For example, HARQ-ACK (j) is generated by the PDSCH which is scheduled by the PDCCH with DAI=j+1. The time domain bundling is performed based on the HARQ-ACK feedback information being sorted. As shown in FIG. 3, it should be noted that if there is Semi-Persistent Scheduling (SPS) PDSCH transmission in a bundling window, the HARQ-ACK feedback information of each non-SPF sub-frame is sorted first, and the HARQ-ACK feedback information of the SPS sub-frames is placed in front. For example, HARQ-ACK(0) is the HARQ-ACK of the SPS sub-frame, and HARQ-ACK (j) is generated by the PDSCH which is scheduled by the PDCCH with DAI=j, wherein j=1, 2.

TABLE 3

| HARQ-ACK feedback | HARQ-ACK feedback |
|---|---|
| information HARQ-ACK(0), | information HARQ-ACK(0), |
| HARQ-ACK(1), HARQ- ACK(2) | HARQ-ACK(1) after the |
| before the time domain bundling | time domain bundling |
| ACK, ACK, ACK | ACK, ACK |
| ACK, ACK, NACK/DTX, | NACK/DTX, ACK |
| ACK, NACK/DTX, any | ACK, NACK/DTX |
| NACK/DTX, any, any | NACK/DTX, NACK/DTX |

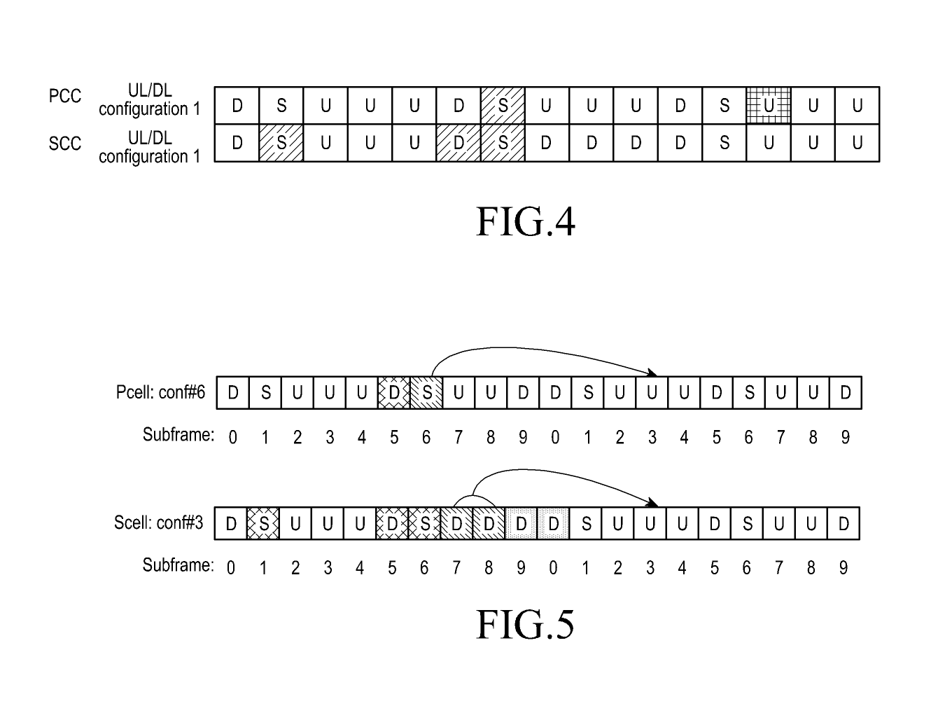

As for the situation that the number of the bundling windows is four, the sorting is performed first according to DAIs in an ascending order and the continuous ACK number, and the time domain bundling is performed. For example, HARQ-ACK (j) is generated by the PDSCH which is scheduled by the PDCCH with DAI=j+1. The time domain bundling is performed based on the HARQ-ACK feedback information being sorted. As shown in FIG. 4, “ACK, ACK, ACK, ACK” and “ACK, DTX, DTX, DTX” adopts a repeated mapping mode. It should be noted that if there is SPS PDSCH transmission in a bundling window, the HARQ-ACK feedback information of each non-SPF sub-frame is sorted first, and the HARQ-ACK feedback information of the SPS sub-frames is placed in front. For example, HARQ-ACK(0) is the HARQ-ACK of the SPS sub-frame, and HARQ-ACK (j) is generated by the PDSCH which is scheduled by the PDCCH with DAI=j, wherein j=1, 2.

TABLE 4

| HARQ-ACK feedback | |
|---|---|
| information HARQ-ACK(0), | HARQ-ACK feedback |
| HARQ-ACK(1), HARQ- ACK(2), | information HARQ-ACK(0), |
| HARQ-ACK(3) before the | HARQ-ACK(1) after the |
| time domain bundling | time domain bundling |
| ACK, ACK, ACK, NACK/DTX | ACK, ACK |
| ACK, ACK ACK, ACK | ACK, NACK/DTX |
| ACK, DTX, DTX, DTX | ACK, NACK/DTX |
| ACK, ACK, NACK/DTX, any | NACK/DTX, ACK |
| ACK, NACK/DTX, any, any except | NACK/DTX, NACK/DTX |
| ACK, DTX, DTX, DTX | |
| NACK/DTX, any, any | NACK/DTX, NACK/DTX |

Exemplary methods of the present invention target the situation that the TDD UL/DL configurations of the two CCs are different, i.e., the bundling windows of the two CCs in a HARQ-ACK feedback period are different.

As for a CC, when the number of the bundling window is one, the time domain bundling and spatial bundling needs not to be performed. When the bundling window adopts the SIMO transmission, only one piece of HARQ-ACK feedback information, i.e., HARQ-ACK(0) is generated. The information may be {ACK} or {NACK/DTX}.

If the MIMO transmission is adopted, two pieces of HARQ-ACK feedback information, i.e., {HARQ-ACK(0), HARQ-ACK(1)} is generated. The information may be {ACK, ACK}, {ACK, NACK}, {NACK, ACK}, {NACK, NACK} or {DTX, DTX}.

If the number of the bundling windows is two, the time domain bundling needs not to be performed. If the CC is configured with the SIMO transmission, two bits of the HARQ-ACK are obtained. If the CC is configured with the MIMO transmission, the spatial bundling needs to be performed, and two bits of HARQ-ACK feedback information are generated. According to this exemplary method, the HARQ-ACK feedback information {HARQ-ACK(0), HARQ-ACK(1)} including {ACK, ACK}, {ACK, NACK/DTX}, {NACK/DTX, ACK} or {NACK/DTX, NACK/DTX} is obtained.

If the number of the bundling windows is three, the time domain bundling needs to be performed. If the CC is configured with the SIMO transmission, two bits of HARQ-ACK feedback information are generated according to the time domain bundling. If the CC is configured with the MIMO transmission, the spatial bundling needs to be performed first, and the time domain bundling or compression is performed, and two bits of HARQ-ACK feedback information are generated at last. According to an exemplary implementation of the present invention, with the time domain bundling or compression mode shown in Table 3, the HARQ-ACK feedback information {HARQ-ACK(0), HARQ-ACK(1)} including ACK, ACK}, {ACK, NACK/DTX}, {NACK/DTX, ACK} or {NACK/DTX, NACK/DTX} can also be obtained.

If the number of the bundling windows is four, the time domain bundling needs to be performed. If the CC is configured with the SIMO transmission, two bits of HARQ-ACK feedback information are generated according to the time domain bundling. If the CC is configured with the MIMO transmission, the spatial bundling needs to be performed first, and the time domain bundling or compression is performed, and two bits of HARQ-ACK feedback information are generated at last. According to an exemplary implementation of the present invention, with the time domain bundling or compression mode shown in Table 4, the HARQ-ACK feedback information {HARQ-ACK(0), HARQ-ACK(1)} including {ACK, ACK}, {ACK, NACK/DTX}, {NACK/DTX, ACK} or {NACK/DTX, NACK/DTX} can also be obtained.

Thus, the HARQ-ACK feedback information of the two CCs is combined, and the HARQ-ACK information is fed back through channel selection.

For instance, it is assumed that the number of the bundling windows of CC0 is one, and the number of bundling windows of CC1 is larger than one. When CC0 is configured with the SIMO transmission, the HARQ-ACK feedback information of CC0 is {ACK} or {NACK/DTX}. The two pieces of HARQ-ACK feedback information {HARQ-ACK(0), HARQ-ACK(1)} including {ACK, ACK}, {ACK, NACK/DTX}, {NACK/DTX, ACK}, or {NACK/DTX, NACK/DTX} is obtained after performing bundling and compression on the HARQ-ACK feedback information of CC1. Thus, a feedback mapping table of PUCCH format 1b of the channel selection is obtained by combining the HARQ-ACK feedback information of CC0 and CC1. The feedback mapping table is shown in Table 5.

TABLE 5

| CC1 | CC0 | | |
|---|---|---|---|
| Two bits of | 1 bit of | | |
| HARQ-ACK | HARQ-ACK | | |
| feedback | feedback | | Constel- |
| information | information | Resource | lation |
| HARQ-ACK(0), | HARQ-ACK(0) | n_{PUCCH}⁽¹⁾ | b(0)b(1) |
| HARQ-ACK(1) | | | |
| ACK, ACK | ACK | n_{PUCCH, 2}⁽¹⁾ | 1, 1 |
| ACK, ACK | NACK/DTX | n_{PUCCH, 1}⁽¹⁾ | 1, 0 |
| ACK, NACK/DTX | ACK | n_{PUCCH, 2}⁽¹⁾ | 1, 0 |
| ACK, NACK/DTX | NACK/DTX | n_{PUCCH, 0}⁽¹⁾ | 1, 1 |
| NACK/DTX, ACK | ACK | n_{PUCCH, 2}⁽¹⁾ | 0, 1 |
| NACK/DTX, ACK | NACK/DTX | n_{PUCCH, 1}⁽¹⁾ | 0, 1 |
| NACK/DTX, NACK/DTX | ACK | n_{PUCCH, 2}⁽¹⁾ | 0, 0 |
| NACK, NACK/DTX | NACK/DTX | n_{PUCCH, 0}⁽¹⁾ | 0, 0 |

| | | |
|---|---|---|
| DTX, NACK/DTX | NACK/DTX | No Transmission |

When CC0 is configured with the MIMO transmission, the HARQ-ACK feedback information of CC0 is {ACK, ACK}, {ACK, NACK}, {NACK, ACK}, {NACK, NACK} or {DTX, DTX}. The two pieces of HARQ-ACK feedback information {HARQ-ACK(0), HARQ-ACK(1)} including {ACK, ACK}, {ACK, NACK/DTX}, {NACK/DTX, ACK} or {NACK/DTX, NACK/DTX} is obtained after performing bundling and compression on the HARQ-ACK feedback information of CC1. Thus, a feedback mapping table of PUCCH format 1b of the channel selection is obtained by combining the HARQ-ACK feedback information of CC0 and CC1. The feedback mapping table is shown in Table 6.

TABLE 6

| CC1 | CC0 | | |
|---|---|---|---|
| 2 bits of | 2 bits of | | |
| HARQ-ACK | HARQ-ACK | | |
| feedback | feedback | | |
| information | information | | Constel- |
| group | group | Resource | lation |
| HARQ-ACK(0), | HARQ-ACK(0), | n_{PUCCH}⁽¹⁾ | b(0), b(1) |
| HARQ-ACK(1) | HARQ-ACK(1), | | |
| | HARQ-ACK(2) | | |
| ACK, ACK | ACK, ACK | n_{PUCCH, 1}⁽¹⁾ | 1, 1 |
| NACK/DTX, ACK | ACK, ACK | n_{PUCCH, 1}⁽¹⁾ | 0, 0 |
| ACK, NACK/DTX | ACK, ACK | n_{PUCCH, 3}⁽¹⁾ | 1, 1 |
| NACK/DTX, NACK/DTX | ACK, ACK | n_{PUCCH, 3}⁽¹⁾ | 0, 1 |
| ACK, ACK | NACK, ACK | n_{PUCCH, 0}⁽¹⁾ | 1, 0 |
| NACK/DTX, ACK | NACK, ACK | n_{PUCCH, 3}⁽¹⁾ | 1, 0 |
| ACK, NACK/DTX | NACK, ACK | n_{PUCCH, 0}⁽¹⁾ | 0, 1 |
| NACK/DTX, NACK/DTX | NACK, ACK | n_{PUCCH, 3}⁽¹⁾ | 0, 0 |
| ACK, ACK | ACK, NACK | n_{PUCCH, 2}⁽¹⁾ | 1, 1 |
| NACK/DTX, ACK | ACK, NACK | n_{PUCCH, 2}⁽¹⁾ | 0, 1 |
| ACK, NACK/DTX | ACK, NACK | n_{PUCCH, 2}⁽¹⁾ | 1, 0 |
| NACK/DTX, NACK/DTX | ACK, NACK | n_{PUCCH, 2}⁽¹⁾ | 0, 0 |
| ACK, ACK | Nack, Nack | n_{PUCCH, 1}⁽¹⁾ | 1, 0 |
| | or DTX, DTX | | |
| NACK/DTX, ACK | Nack, Nack | n_{PUCCH, 1}⁽¹⁾ | 0, 1 |
| | or DTX, DTX | | |
| ACK, NACK/DTX | Nack, Nack | n_{PUCCH, 0}⁽¹⁾ | 1, 1 |
| | or DTX, DTX | | |
| NACK, NACK/DTX | Nack, Nack | n_{PUCCH, 0}⁽¹⁾ | 0, 0 |
| | or DTX, DTX | | |

| | | |
|---|---|---|
| DTX, NACK/DTX | Nack, Nack | No Transmission |
| | or DTX, DTX | |

When the CC0 is configured with the MIMO transmission, the HARQ-ACK feedback information of CC0 is {ACK, ACK}, {ACK, NACK}, {NACK, ACK}, {NACK, NACK} or {DTX, DTX}. Since {ACK, NACK} is a sub-set of {ACK, NACK/DTX}, {NACK, ACK} is a sub-set of {NACK/DTX, ACK}, {NACK, NACK} and {DTX, DTX} are sub-sets of {NACK/DTX, NACK/DTX}. For the purpose of simplifying regulatory, Table 6 may be expressed as Table 7.

TABLE 7

| CC1 | CC0 | | |
|---|---|---|---|
| 2 bits of | 2 bits of | | |
| HARQ-ACK | HARQ-ACK | | |
| feedback | feedback | | Constel- |
| information group | information group | Resource | lation |
| HARQ-ACK(0), | HARQ-ACK(0), | n_{PUCCH}⁽¹⁾ | b(0), b(1) |
| HARQ-ACK(1) | HARQ-ACK(1) | | |
| ACK, ACK | ACK, ACK | n_{PUCCH, 1}⁽¹⁾ | 1, 1 |
| NACK/DTX, ACK | ACK, ACK | n_{PUCCH, 1}⁽¹⁾ | 0, 0 |
| ACK, NACK/DTX | ACK, ACK | n_{PUCCH, 3}⁽¹⁾ | 1, 1 |
| NACK/DTX, | ACK, ACK | n_{PUCCH, 3}⁽¹⁾ | 0, 1 |
| NACK/DTX | | | |
| ACK, ACK | NACK/DTX, ACK | n_{PUCCH, 0}⁽¹⁾ | 1, 0 |
| NACK/DTX, ACK | NACK/DTX, ACK | n_{PUCCH, 3}⁽¹⁾ | 1, 0 |
| ACK, NACK/DTX | NACK/DTX, ACK | n_{PUCCH, 0}⁽¹⁾ | 0, 1 |
| NACK/DTX, | NACK/DTX, ACK | n_{PUCCH, 3}⁽¹⁾ | 0, 0 |
| NACK/DTX | | | |
| ACK, ACK | ACK, NACK/DTX | n_{PUCCH, 2}⁽¹⁾ | 1, 1 |
| NACK/DTX, ACK | ACK, NACK/DTX | n_{PUCCH, 2}⁽¹⁾ | 0, 1 |
| ACK, NACK/DTX | ACK, NACK/DTX | n_{PUCCH, 2}⁽¹⁾ | 1, 0 |
| NACK/DTX, | ACK, NACK/DTX | n_{PUCCH, 2}⁽¹⁾ | 0, 0 |
| NACK/DTX | | | |
| ACK, ACK | NACK/DTX, | n_{PUCCH, 1}⁽¹⁾ | 1, 0 |
| | NACK/DTX | | |
| NACK/DTX, ACK | NACK/DTX, | n_{PUCCH, 1}⁽¹⁾ | 0, 1 |
| | NACK/DTX | | |
| ACK, NACK/DTX | NACK/DTX, | n_{PUCCH, 0}⁽¹⁾ | 1, 1 |
| | NACK/DTX | | |
| NACK, NACK/DTX | NACK/DTX, | n_{PUCCH, 0}⁽¹⁾ | 0, 0 |
| | NACK/DTX | | |

| | | |
|---|---|---|
| DTX, NACK/DTX | NACK/DTX, | No Transmission |
| | NACK/DTX | |

Some exemplary embodiments of the present invention are provided below to further describe the first exemplary embodiment of the present invention. The first exemplary embodiment is used for obtaining the feedback mapping table of the PUCCH format 1b of the channel selection.

### Exemplary Embodiment One

In this exemplary embodiment of the present invention, it is assumed that the CC0 is an Scell, the number of the bundling window is one, and the CC0 is configured with the SIMO transmission, CC1 is the Pcell, wherein the number of the bundling windows is three. Thus, the CC0 may obtain one bit of the HARQ-ACK feedback information. Since the number of the bundling windows of CC1 is three, if the CC1 is configured with the MIMO transmission, the spatial bundling is made first. Accordingly, no matter the MIMO transmission or the SIMO transmission, the CC1 may obtain three bits of the HARQ-ACK feedback information. The feedback mapping table of the PUCCH format 1b of the channel selection may be obtained with reference to Table 3 and Table 5. The feedback mapping table is shown in Table 8.

TABLE 8

| Pcell | Scell | | |
|---|---|---|---|
| CC1 | CC0 | | |
| 3 bits of | 1 bit of | | |
| HARQ-ACK | HARQ-ACK | | |
| feedback | feedback | | Constel- |
| information | information | Resource | lation |
| HARQ-ACK(0), | HARQ-ACK(0) | n_{PUCCH}⁽¹⁾ | b(0)b(1) |
| HARQ-ACK(1), | | | |
| HARQ-ACK(2) | | | |
| ACK, ACK, ACK | ACK | n_{PUCCH, 2}⁽¹⁾ | 1, 1 |
| ACK, ACK, ACK | NACK/DTX | n_{PUCCH, 1}⁽¹⁾ | 1, 0 |
| ACK, NACK/DTX, any | ACK | n_{PUCCH, 2}⁽¹⁾ | 1, 0 |
| ACK, NACK/DTX, any | NACK/DTX | n_{PUCCH, 0}⁽¹⁾ | 1, 1 |
| ACK, ACK, NACK/DTX | ACK | n_{PUCCH, 2}⁽¹⁾ | 0, 1 |
| ACK, ACK, NACK/DTX | NACK/DTX | n_{PUCCH, 1}⁽¹⁾ | 0, 1 |
| NACK/DTX, any, any | ACK | n_{PUCCH, 2}⁽¹⁾ | 0, 0 |
| NACK, any, any | NACK/DTX | n_{PUCCH, 0}⁽¹⁾ | 0, 0 |

| | | |
|---|---|---|
| DTX, any, any | NACK/DTX | No Transmission |

According to a protocol of Release 10, there are two criteria. The first one is a bundling criterion, that is, the spatial bundling and time domain bundling needs not to be made if the total HARQ-ACK of two CCs is less than or equal to four. The second one is a generation criterion of the bits of the HARQ-ACK and determination criterion of transmission resources, that is, each CC generates two HARQ-ACK bits and two transmission resources.

As for the situation shown in FIG. 4, according to the first criterion, there are four HARQ-ACK bits, and the time domain bundling needs not to be made on the HARQ-ACK feedback information of the SCC to compress the bits of the HARQ-ACK feedback information. In this exemplary embodiment of the present invention, after the spatial bundling, in the case that the number of the bits of the HARQ-ACK feedback information of the two CCs is four, the time domain bundling is performed on the CC1 to generate two HARQ-ACK feedback bits, which modifies the first criterion mentioned above.

### Exemplary Embodiment Two

In this exemplary embodiment of the present invention, it is assumed that the CC0 is the Scell, the number of the bundling window is one, and the CC0 is configured with the SIMO transmission, CC1 is the Pcell, wherein the number of the bundling windows is four. Thus, the CC0 may obtain one bit of the HARQ-ACK feedback information. Since the number of the bundling windows of CC1 is four, if the CC1 is configured with the MIMO transmission, the spatial bundling is made first. Accordingly, no matter the MIMO transmission or the SIMO transmission, the CC1 may obtain four bits of HARQ-ACK feedback information. The feedback mapping table of the PUCCH format 1b of the channel selection may be obtained with reference to Table 4 and Table 5. The feedback mapping table is shown in Table 9.

TABLE 9

| Pcell | Scell | | |
|---|---|---|---|
| CC1 | CC0 | | |
| 4 bits of | 1 bit of | | |
| HARQ-ACK | HARQ-ACK | | |
| feedback | feedback | | Constel- |
| information group | information group | Resource | lation |
| HARQ-ACK(0), HARQ- | HARQ-ACK(0) | n_{PUCCH}⁽¹⁾ | b(0)b(1) |
| ACK(1), HARQ-ACK(2), | | | |
| HARQ-ACK (3) | | | |
| ACK, ACK, ACK | ACK | n_{PUCCH, 2}⁽¹⁾ | 1, 1 |
| NACK/DTX | | | |
| ACK, ACK, ACK | NACK/DTX | n_{PUCCH, 1}⁽¹⁾ | 1, 0 |
| NACK/DTX | | | |
| ACK, ACK, ACK, ACK | ACK | n_{PUCCH, 2}⁽¹⁾ | 1, 0 |
| ACK, DTX, DTX, DTX | ACK | n_{PUCCH, 2}⁽¹⁾ | 1, 0 |
| ACK, ACK, ACK, ACK | NACK/DTX | n_{PUCCH, 0}⁽¹⁾ | 1, 1 |
| ACK, DTX, DTX, DTX | | | |
| ACK, ACK, NACK/DTX, | ACK | n_{PUCCH, 2}⁽¹⁾ | 0, 1 |
| any | | | |
| ACK, ACK, NACK/DTX, | NACK/DTX | n_{PUCCH, 1}⁽¹⁾ | 0, 1 |
| any | | | |
| NACK/DTX, any, any, | ACK | n_{PUCCH, 2}⁽¹⁾ | 0, 0 |
| any | | | |
| (ACK, NACK/DTX, any, | ACK | n_{PUCCH, 2}⁽¹⁾ | 0, 0 |
| any), except for (ACK, | | | |
| DTX, DTX, DTX) | | | |
| NACK, any, any, any | NACK/DTX | n_{PUCCH, 0}⁽¹⁾ | 0, 0 |

| | | |
|---|---|---|
| DTX, any, any, any | NACK/DTX | No Transmission |

### Exemplary Embodiment Three

In this exemplary embodiment of the present invention, it is assumed that the CC0 is the Pcell, the number of the bundling window is one, and the CC0 is configured with the MIMO transmission. CC1 is the Scell and the number of the bundling windows is three. Thus, the CC0 may obtain two bits of the HARQ-ACK feedback information. Since the number of the bundling windows of CC1 is three, if the CC1 is configured with the MIMO transmission, the spatial bundling is made first. Accordingly, no matter the MIMO transmission or the SIMO transmission, the CC1 may obtain three bits of HARQ-ACK feedback information. The feedback mapping table of the PUCCH format 1b of the channel selection may be obtained with reference to Table 3 and Table 7. The feedback mapping table is shown in Table 10.

TABLE 10

| Pcell | Scell | | |
|---|---|---|---|
| CC0 | CC1 | | |
| 2 bits of | 3 bits of | | |
| HARQ-ACK | HARQ-ACK | | |
| feedback | feedback | | Constel- |
| information group | information group | Resource | lation |
| HARQ-ACK(0), | HARQ-ACK(0), | n_{PUCCH}⁽¹⁾ | b(0), b(1) |
| HARQ-ACK(1) | HARQ-ACK(1), | | |
| | HARQ-ACK(2) | | |
| ACK, ACK | ACK, ACK, ACK | n_{PUCCH, 1}⁽¹⁾ | 1, 1 |
| NACK/DTX, ACK | ACK, ACK, ACK | n_{PUCCH, 1}⁽¹⁾ | 0, 0 |
| ACK, NACK/DTX | ACK, ACK, ACK | n_{PUCCH, 3}⁽¹⁾ | 1, 1 |
| NACK/DTX, | ACK, ACK, ACK | n_{PUCCH, 3}⁽¹⁾ | 0, 1 |
| NACK/DTX | | | |
| ACK, ACK | ACK, ACK, | n_{PUCCH, 0}⁽¹⁾ | 1, 0 |
| | NACK/DTX | | |
| NACK/DTX, ACK | ACK, ACK, | n_{PUCCH, 3}⁽¹⁾ | 1, 0 |
| | NACK/DTX | | |
| ACK, NACK/DTX | ACK, ACK, | n_{PUCCH, 0}⁽¹⁾ | 0, 1 |
| | NACK/DTX | | |
| NACK/DTX, | ACK, ACK, | n_{PUCCH, 3}⁽¹⁾ | 0, 0 |
| NACK/DTX | NACK/DTX | | |
| ACK, ACK | ACK, NACK/DTX, | n_{PUCCH, 2}⁽¹⁾ | 1, 1 |
| | any | | |
| NACK/DTX, ACK | ACK, NACK/DTX, | n_{PUCCH, 2}⁽¹⁾ | 0, 1 |
| | any | | |
| ACK, NACK/DTX | ACK, NACK/DTX, | n_{PUCCH, 2}⁽¹⁾ | 1, 0 |
| | any | | |
| NACK/DTX, | ACK, NACK/DTX, | n_{PUCCH, 2}⁽¹⁾ | 0, 0 |
| NACK/DTX | any | | |
| ACK, ACK | NACK/DTX, any, | n_{PUCCH, 1}⁽¹⁾ | 1, 0 |
| | any | | |
| NACK/DTX, ACK | NACK/DTX, any, | n_{PUCCH, 1}⁽¹⁾ | 0, 1 |
| | any | | |
| ACK, NACK/DTX | NACK/DTX, any, | n_{PUCCH, 0}⁽¹⁾ | 1, 1 |
| | any | | |
| NACK, NACK/DTX | NACK/DTX, any, | n_{PUCCH, 0}⁽¹⁾ | 0, 0 |
| | any | | |

| | | |
|---|---|---|
| DTX, NACK/DTX | NACK/DTX, any, | No Transmission |
| | any | |

### Exemplary Embodiment Four

In this exemplary embodiment of the present invention, it is assumed that the CC0 is the Pcell, the number of the bundling window is one, and the CC0 is configured with the MIMO transmission. CC1 is the Scell and the number of the bundling windows is four. Thus, the CC0 may obtain two bits of the HARQ-ACK feedback information. Since the number of the bundling windows of CC1 is four, if the CC1 is configured with the MIMO transmission, the spatial bundling is made first. Accordingly, no matter the MIMO transmission or the SIMO transmission, the CC1 may obtain four bits of HARQ-ACK feedback information. The feedback mapping table of the PUCCH format 1b of the channel selection may be obtained with reference to Table 4 and Table 7. The feedback mapping table is shown in Table 11.

TABLE 11

| Pcell | Scell | | |
|---|---|---|---|
| CC0 | CC1 | | |
| 2 bits of | 4 bits of | | |
| HARQ-ACK | HARQ-ACK | | |
| feedback | feedback | | Constel- |
| information group | information group | Resource | lation |
| HARQ-ACK(0), | HARQ-ACK(0), | n_{PUCCH}⁽¹⁾ | b(0), b(1) |
| HARQ-ACK(1), | HARQ-ACK(1), | | |
| | HARQ-ACK(2), | | |
| | HARQ-ACK(3) | | |
| ACK, ACK | ACK, ACK, ACK, | n_{PUCCH, 1}⁽¹⁾ | 1, 1 |
| | NACK/DTX | | |
| NACK/DTX, | ACK, ACK, ACK, | n_{PUCCH, 1}⁽¹⁾ | 0, 0 |
| ACK | NACK/DTX | | |
| ACK, | ACK, ACK, ACK, | n_{PUCCH, 3}⁽¹⁾ | 1, 1 |
| NACK/DTX | NACK/DTX | | |
| NACK/DTX, | ACK, ACK, ACK, | n_{PUCCH, 3}⁽¹⁾ | 0, 1 |
| NACK/DTX | NACK/DTX | | |
| ACK, ACK | ACK, ACK, NACK/DTX, | n_{PUCCH, 0}⁽¹⁾ | 1, 0 |
| | any | | |
| NACK/DTX, | ACK, ACK, NACK/DTX, | n_{PUCCH, 3}⁽¹⁾ | 1, 0 |
| ACK | any | | |
| ACK, | ACK, ACK, NACK/DTX, | n_{PUCCH, 0}⁽¹⁾ | 0, 1 |
| NACK/DTX | any | | |
| NACK/DTX, | ACK, ACK, NACK/DTX, | n_{PUCCH, 3}⁽¹⁾ | 0, 0 |
| NACK/DTX | any | | |
| ACK, ACK | ACK, DTX, DTX, DTX | n_{PUCCH, 2}⁽¹⁾ | 1, 1 |
| ACK, ACK | ACK, ACK, ACK, ACK | n_{PUCCH, 2}⁽¹⁾ | 1, 1 |
| NACK/DTX, | ACK, DTX, DTX, DTX | n_{PUCCH, 2}⁽¹⁾ | 0, 1 |
| ACK | | | |
| NACK/DTX, | ACK, ACK, ACK, ACK | n_{PUCCH, 2}⁽¹⁾ | 0, 1 |
| ACK | | | |
| ACK, | ACK, DTX, DTX, DTX | n_{PUCCH, 2}⁽¹⁾ | 1, 0 |
| NACK/DTX | | | |
| ACK, | ACK, ACK, ACK, ACK | n_{PUCCH, 2}⁽¹⁾ | 1, 0 |
| NACK/DTX | | | |
| NACK/DTX, | ACK, DTX, DTX, DTX | n_{PUCCH, 2}⁽¹⁾ | 0, 0 |
| NACK/DTX | | | |
| NACK/DTX, | ACK, ACK, ACK, ACK | n_{PUCCH, 2}⁽¹⁾ | 0, 0 |
| NACK/DTX | | | |
| ACK, ACK | NACK/DTX, any, any, | n_{PUCCH, 1}⁽¹⁾ | 1, 0 |
| | any | | |
| ACK, ACK | (ACK, NACK/DTX, any, | n_{PUCCH, 1}⁽¹⁾ | 1, 0 |
| | any), except for (ACK, | | |
| | DTX, DTX, DTX) | | |
| NACK/DTX, | NACK/DTX, any, any, | n_{PUCCH, 1}⁽¹⁾ | 0, 1 |
| ACK | any | | |
| NACK/DTX, | (ACK, NACK/DTX, any, | n_{PUCCH, 1}⁽¹⁾ | 0, 1 |
| ACK | any), except for (ACK, | | |
| | DTX, DTX, DTX) | | |
| ACK, | NACK/DTX, any, any, | n_{PUCCH, 0}⁽¹⁾ | 1, 1 |
| NACK/DTX | any | | |
| ACK, | (ACK, NACK/DTX, any, | n_{PUCCH, 0}⁽¹⁾ | 1, 1 |
| NACK/DTX | any), except for (ACK, | | |
| | DTX, DTX, DTX) | | |
| NACK, | NACK/DTX, any, any, | n_{PUCCH, 0}⁽¹⁾ | 0, 0 |
| NACK/DTX | any | | |
| NACK, | (ACK, NACK/DTX, any, | n_{PUCCH, 0}⁽¹⁾ | 0, 0 |
| NACK/DTX | any), except for (ACK, | | |
| | DTX, DTX, DTX) | | |

| | | |
|---|---|---|
| DTX, | NACK/DTX, any, any, | DTX |
| NACK/DTX | any | |
| DTX, | (ACK, NACK/DTX, any, | |
| NACK/DTX | any), except for (ACK, | |
| | DTX, DTX, DTX) | |

A resource mapping method corresponding to the principle of the group bundling as described in the first exemplary embodiment of the present invention is provided below.

The exemplary methods of the present invention target the situation that the TDD UL/DL configurations of two CCs are different, i.e., the bundling windows of the two CCs in a HARQ-ACK feedback period are different.

If the number of the bundling window on a CC is one and the bundling window is configured with the SIMO transmission, the PUCCH resource is mapped from the index of the minimum Control Channel Element (CCE) (may be referred to as the index of the first CCE), which is used by the PDCCH scheduling the PDSCH, or indicated by an ACK/NACK Resource Indicator (ARI) on the PDCCH scheduling the PDSCH. Thereafter, only one resource of the PUCCH format 1a/1b is needed. If the index of the first CCE is denoted as nCCE, when the bundling window is configured with the MIMO transmission, the PUCCH resources are mapped from the index nCCE of the first CCE and the index nCCE+1 of the second CCE which are used by the PDCCHs scheduling the PDSCHs, or indicated by the ARIs on the PDCCHs scheduling the PDSCHs. Thereafter, two resources of the PUCCH format 1a/1b are needed.

If the number of the bundling windows on a certain CC is two, the two PUCCH resources are mapped from the indexes nCCE of the first CCEs which are used by the PDCCHs scheduling the PDSCHs of sub-frame 1 and sub-frame 2, or indicated by the ARIs on the PDCCHs scheduling the PDSCHs. Thereafter, two resources of the PUCCH format 1a/1b are needed.

If the number of the bundling windows on a certain CC is larger than two, the two PUCCH resources are mapped from the indexes nCCE of the first CCEs which are used by the PDCCHs, which schedule the PDSCHs and DAIs of which are respective 1 and 2, or indicated by the ARIs on the PDCCHs scheduling the PDSCHs. Thereafter, two resources of the PUCCH format 1a/1b are needed.

Specifically, when the bundling window is configured with the SIMO transmission, only one resource of the PUCCH format 1a/1b is needed. If the cell is the Pcell, the PUCCH resource is mapped from the index of the minimum CCE which is used by the PDCCH scheduling the PDSCH. If the cell is the Scell, the PDSCH of the Scell is scheduled crossing cells by the PDCCH of the Pcell, and the PUCCH resource is mapped from the index nCCE of the minimum CCE which is used by the PDCCH scheduling the PDSCH. If the cell is the Scell, non cross-cell scheduling is adopted, and the PUCCH resource is indicated by the ARI on the PDCCH scheduling the PDSCH.

When the bundling window is configured with the MIMO transmission, two resources of the PUCCH format 1a/1b are needed. If the cell is the Pcell, the PUCCH resources are mapped from the index of the minimum CCE and the index of the second minimum CCE (also referred to as the index of the second index) which are used by the PDCCHs scheduling the PDSCHs. If the cell is the Scell, the PDSCH of the Scell is scheduled crossing cells by the PDCCH of the Pcell, and the PUCCH resources are mapped from the index nCCE of the minimum CCE and the index nCCE+1 of the second minimum CCE which are used by the PDCCHs scheduling the PDSCHs. If the cell is the Scell, the non cross-cell scheduling is adopted, and the two PUCCH resources are indicated by the ARIs on the PDCCHs scheduling the PDSCHs.

When the number of the bundling windows is two, two resources of the PUCCH format 1a/1b are needed. If the cell is the Pcell, the PUCCH resources are mapped from the indexes of the minimum CCEs which are used by the PDCCHs scheduling the PDSCHs of sub-frame 1 and sub-frame 2. If the cell is the Scell, the PDSCH of the Scell is scheduled crossing cells by the PDCCH of the Pcell, and the PUCCH resources are mapped from the indexes nCCE of the minimum CCEs which are used by the PDCCHs scheduling the PDSCHs of sub-frame 0 and sub-frame 1. If the cell is the Scell, the non cross-cell scheduling is adopted, and the two PUCCH resources are indicated by the ARIs on the PDCCHs scheduling the PDSCHs.

When the number of the bundling windows is larger than two, two resources of the PUCCH format 1a/1b are needed. If the cell is the Pcell, the PUCCH resources are mapped from the index nCCE of the minimum CCE which is used by each of the PDCCHs, which schedule the PDSCHs, and DAIs of which are respective 1 and 2. If the cell is the Scell, the PDSCH of the Scell is scheduled crossing cells by the PDCCH of the Pcell, and the PUCCH resources are mapped from the index of the minimum CCE or the index nCCE of the first CCE which is used by each of the PDCCHs, which schedule the PDSCHs, and DAIs of which are respective 1 and 2. If the cell is the Scell, a non-cross scheduling is adopted, and the two PUCCH resources are indicated by the ARIs on the PDCCHs scheduling the PDSCHs.

Some exemplary embodiments of the present invention are provided below to further describe a resource mapping method of the first exemplary embodiment of the present invention.

### Exemplary Embodiment Five

In this exemplary embodiment of the present invention, it is assumed that CC0 is the Pcell, the number of the bundling window is one, and the CC0 is configured with the SIMO transmission. CC1 is the Scell and the number of the bundling windows is two. Therefore, the CC0 maps out one PUCCH resource. The PUCCH resource of the CC0 is mapped from an index nCCE of the minimum CCE which is used by the PDCCH scheduling the PDSCH. CC1 needs two PUCCH resources and if the CC1 is scheduled by the PDCCH of the Pcell CC0 crossing cells, the two PUCCH resources of the CC1 are mapped from the indexes nCCE of the minimum CCEs which are used by the PDCCHs. The PDCCHs schedule the PDSCHs of the CC1 crossing cells and are the PDCCHs of sub-frame 0 and sub-frame 1 of the Pcell CC0.

TABLE 12
PUCCH resource (j)

| | |
|---|---|
| CC1 | CC0 |
| Scell | Pcell |

| | PUCCH | PUCCH | PUCCH |
|---|---|---|---|
| | resource (0) | resource (1) | resource (2) |
| Cross- | Index nCCE of | Index nCCE of | Index nCCE |
| carrier | the first CCE | the first CCE | of the |
| scheduling | of sub-frame 0 | of sub-frame 1 | first CCE |
| Non cross- | ARI | ARI | Index nCCE |
| carrier | | | of the |
| scheduling | | | first CCE |

### Exemplary Embodiment Six

In this exemplary embodiment of the present invention, it is assumed that the CC0 is the Pcell, the number of the bundling window is one, and the CC0 is configured with the MIMO transmission. CC1 is the Scell and the number of the bundling windows is two. Thereafter, the PUCCH resource mapping relationship is shown in Table 13.

TABLE 13
PUCCH resource (j)

| | CC0 | | CC1 | |
|---|---|---|---|---|
| | Pcell | | Scell | |
| | PUCCH | PUCCH | PUCCH | PUCCH |
| | resource (0) | resource (1) | resource (2) | resource (3) |
| Cross- | Index nCCE | Index | Index nCCE | Index nCCE |
| carrier | of the | nCCE + | of the first | of the first |
| scheduling | first CCE | 1 of the | CCE of sub- | CCE of sub- |
| | | second CCE | frame 0 | frame 1 |
| Non cross- | Index nCCE | Index | ARI | ARI |
| carrier | of the | nCCE + | | |
| scheduling | first CCE | 1 of the | | |
| | | second CCE | | |

### Exemplary Embodiment Seven

In this exemplary embodiment of the present invention, it is assumed that the CC0 is the Pcell, the number of the bundling window is one, and the CC0 is configured with the SIMO transmission. CC1 is the Scell and the number of the bundling windows is larger than two. Thereafter, the PUCCH resource mapping relationship is shown in Table 14.

TABLE 14
PUCCH resource (j)

| | |
|---|---|
| CC1 | CC0 |
| Scell | Pcell |

| | PUCCH | PUCCH | PUCCH |
|---|---|---|---|
| | resource (0) | resource (1) | resource (2) |
| Cross- | Index nCCE of | Index nCCE of | Index nCCE |
| carrier | the first CCE | the first CCE | of the |
| scheduling | of a sub-frame, | of a sub-frame, | first CCE |
| | DAI of which | DAI of which | |
| | is 1 | is 2 | |
| Non cross- | ARI | ARI | Index nCCE |
| carrier | | | of the |
| scheduling | | | first CCE |

### Exemplary Embodiment Eight

In this exemplary embodiment of the present invention, it is assumed that the CC0 is the Pcell, the number of the bundling window is one, and the CC0 is configured with the MIMO transmission. CC1 is the Scell and the number of the bundling windows is larger than two. Thereafter, the PUCCH resource mapping relationship is shown in Table 15.

TABLE 15
PUCCH resource (j)

| | CC0 | | CC1 | |
|---|---|---|---|---|
| | Pcell | | Scell | |
| | PUCCH | PUCCH | PUCCH | PUCCH |
| | resource (0) | resource (1) | resource (2) | resource (3) |
| Cross- | Index nCCE | Index | Index nCCE | Index nCCE |
| carrier | of the | nCCE + | of the first | of the first |
| scheduling | first CCE | 1 of the | CCE of a sub- | CCE of a sub- |
| | | second CCE | frame, DAI of | frame, DAI of |
| | | | which is 1 | which is 2 |
| Non cross- | Index nCCE | Index | ARI | ARI |
| carrier | of the | nCCE + | | |
| scheduling | first CCE | 1 of the | | |
| | | second CCE | | |

### Exemplary Embodiment Nine

In this exemplary embodiment of the present invention, it is assumed that the CC0 is the Scell, the number of the bundling window is one, and the CC0 is configured with the SIMO transmission. CC1 is the Pcell and the number of the bundling windows is two. Thereafter, the PUCCH resource mapping relationship is shown in Table 16.

TABLE 16
PUCCH resource (j)

| | |
|---|---|
| CC1 | CC0 |
| Pcell | Scell |

| | PUCCH | PUCCH | PUCCH |
|---|---|---|---|
| | resource (0) | resource (1) | resource (2) |
| Cross- | Index nCCE of | Index nCCE of | Index nCCE |
| carrier | the first CCE | the first CCE | of the |
| scheduling | of sub-frame 0 | of sub-frame 1 | first CCE |
| Non cross- | Index nCCE of | Index nCCE of | ARI |
| carrier | the first CCE | the first CCE | |
| scheduling | of sub-frame 0 | of sub-frame 1 | |

### Exemplary Embodiment Ten

In this exemplary embodiment of the present invention, it is assumed that the CC0 is the Scell, the number of the bundling window is one, and the CC0 is configured with the MIMO transmission. CC1 is the Pcell and the number of the bundling windows is two. Thereafter, the PUCCH resource mapping relationship is shown in Table 17.

TABLE 17
PUCCH resource (j)

| | CC1 | | CC0 | |
|---|---|---|---|---|
| | PUCCH | PUCCH | PUCCH | PUCCH |
| | resource (0) | resource (1) | resource (2) | resource (3) |
| Cross- | Index nCCE | Index nCCE | Index nCCE | Index |
| carrier | of the first | of the first | of the | nCCE + |
| scheduling | CCE of sub- | CCE of sub- | first CCE | 1 of the |
| | frame 0 | frame 1 | | second CCE |
| Non cross- | Index nCCE | Index nCCE | ARI | ARI |
| carrier | of the first | of the first | | |
| scheduling | CCE of sub- | CCE of sub- | | |
| | frame 0 | frame 1 | | |

### Exemplary Embodiment Eleven

In this exemplary embodiment of the present invention, it is assumed that the CC0 is the Scell, the number of the bundling window is one, and the CC0 is configured with the SIMO transmission. CC1 is the Pcell and the number of the bundling windows is larger than two. Thereafter, the PUCCH resource mapping relationship is shown in Table 18.

TABLE 18
PUCCH resource (j)

| | |
|---|---|
| CC1 | CC0 |
| Pcell | Scell |

| | PUCCH | PUCCH | PUCCH |
|---|---|---|---|
| | resource (0) | resource (1) | resource (2) |
| Cross- | Index nCCE | Index nCCE | Index nCCE |
| carrier | of the first | of the first | of the first |
| scheduling | CCE of a sub- | CCE of a sub- | CCE of a sub- |
| | frame, DAI of | frame, DAI of | frame, DAI of |
| | which is 1 | which is 2 | which is 1 |
| Non cross- | Index nCCE | Index nCCE | ARI |
| carrier | of the first | of the first | |
| scheduling | CCE of a sub- | CCE of a sub- | |
| | frame, DAI of | frame, DAI of | |
| | which is 1 | which is 2 | |

### Exemplary Embodiment Twelve

In this exemplary embodiment of the present invention, it is assumed that the CC0 is the Scell, the number of the bundling window is one, and the CC0 is configured with the MIMO transmission. CC1 is the Pcell and the number of the bundling windows is larger than two. Thereafter, the PUCCH resource mapping relationship is shown in Table 19.

TABLE 19
PUCCH resource (j)

| | CC1 | | CC0 | |
|---|---|---|---|---|
| | Pcell | | Scell | |
| | PUCCH | PUCCH | PUCCH | PUCCH |
| | resource (0) | resource (1) | resource (2) | resource (3) |
| Cross- | Index nCCE | Index nCCE | Index nCCE | Index |
| carrier | of the first | of the first | of the | nCCE + |
| scheduling | CCE of a sub- | CCE of a sub- | first CCE | 1 of the |
| | frame, DAI of | frame, DAI of | | second CCE |
| | which is one | which is two | | |
| Non cross- | Index nCCE | Index nCCE | ARI | ARI |
| carrier | of the first | of the first | | |
| scheduling | CCE of a sub- | CCE of a sub- | | |
| | frame, DAI of | frame, DAI of | | |
| | which is one | which is two | | |

Except for the above exemplary methods of the present invention, another exemplary implementation of the spatial bundling adopts a Rel-8 Time bundling method (i.e., a time domain bundling method performed on the HARQ-ACK feedback information with the HARQ-ACK and Selective Repeat (SR)). Other time domain bundling methods may be adopted in an exemplary implementation.

According to the above first exemplary embodiment of the present invention, the HARQ-ACK feedback information of all sub-frames in a HARQ-ACK feedback period of the two CCs is bundled, the mapping of the PUCCH channel resources is performed according to the bundled HARQ-ACK feedback information. This exemplary method has the advantages of low complexity, improved performances and backward compatibility, and will not cause confusion between the base station and terminal when being re-configured.

In the second exemplary embodiment of the present invention, the principle of the group bundling is described below.

If the total number of bits of the HARQ-ACK feedback information of the two CCs configured for the UE is larger than four, the spatial bundling is performed on the HARQ-ACK feedback information of all the sub-frames on the two CCs first.

If the total number of the bits of the HARQ-ACK feedback information which is processed with the spatial bundling is four, the HARQ-ACK feedback information is divided into two groups, to make the total number of bits of the HARQ-ACK feedback information in each group equal to two.

If the total number of the bits of the HARQ-ACK feedback information which is processed with the spatial bundling is still larger than four, the HARQ-ACK feedback information which is processed with the spatial bundling is divided into two groups first, in which each group at least includes two bits. Thereafter, the time domain bundling is performed on the HARQ-ACK feedback information, the total number of the bits of which is larger than two after the grouping to make the total bits of the HARQ-ACK feedback information in each group equal to two.

When the number of the bundling window M0 of CC0 is one, while the number of the bundling windows of the CC1 is three, if both the two CCs are configured with the SIMO transmission, the total number of the bits of the HARQ-ACK of the two CCs is four. The four bits are divided into two groups, each of which is two bits. If a certain CC in the two CCs is configured with the MIMO transmission, or both the two CCs are configured with the MIMO transmission, the spatial bundling is performed on the CCs configured with the MIMO transmission to obtain four bits. Thereafter, the four bits are divided into two groups, each of which is two bits.

When the number of the bundling window M0 of CC0 is one, while the number of the bundling windows of the CC1 is four, if both the two CCs are configured with the SIMO transmission, the total number of the bits of the HARQ-ACK of the two CCs is five. The five bits are divided into two groups. One group is two bits and the other group is three bits. If a certain CC in the two CCs is configured with the MIMO transmission, or both the two CCs are configured with the MIMO transmission, the spatial bundling is performed on the CC configured with the MIMO transmission to obtain five bits, and the five bits are divided into two groups. One group is two bits and the other group is three bits. Thereafter, the time domain bundling is performed on the three bits to obtain two bits. Therefore, two groups, each of which is two bits, are also obtained.

The above exemplary method for dividing the bits into two groups is described below. One HARQ-ACK bit is divided from the HARQ-ACK bits on the CC1, the divided bit is combined with the HARQ-ACK bit on the CC0 to form a group. Meanwhile, the rest of the HARQ-ACK bits in the CC1 are taken as a group. Specifically, the last bit of multiple HARQ-ACK bits in the CC1 may be divided out to form a group with the HARQ-ACK bit in the CC0. The benefit of doing so is that the PUCCH resource mapping method may be simplified. Since the PUCCH resources in the exemplary methods of the present invention are obtained by mapping according to the DAI, the last HARQ-ACK bit is selected to form a group with the HARQ-ACK bit of another CC, which may avoid the influence on the PUCCH resource mapping of the current CC.

In addition, when a group is formed by combining the HARQ-ACK bit divided from the CC1 and the HARQ-ACK bit of the CC0, the HARQ-ACK bit in the CC0 may be taken as the first HARQ-ACK bit of this group, while the HARQ-ACK bit divided from the CC1 is taken as the second HARQ-ACK bit of this group. The benefit of doing so is that the error, which may be caused when the CC is re-configured, may be avoided.

Except for the above exemplary methods, when the group is formed by combining the HARQ-ACK bit divided from the CC1 and the HARQ-ACK bit of the CC0, the HARQ-ACK bit divided from the CC1 may be taken as the first HARQ-ACK bit of this group, while the HARQ-ACK bit taken from the CC1 is taken as the second HARQ-ACK bit of this group.

For example, the first situation is that in a HARQ-ACK feedback period, the number of the bundling window of the CC0 is one, i.e., only one sub-frame, and the CC0 is configured with the SIMO transmission. The HARQ-ACK feedback information of sub-frame 0 of the CC0 is {ACK}, and the total number of bit of the HARQ-ACK feedback information of the CC0 is one. The number of the bundling windows of the CC1 is three, and the CC1 is configured with the MIMO transmission. The HARQ-ACK feedback information of sub-frame 0, sub-frame 1 and sub-frame 2 is {DTX, DTX}, {ACK, ACK} and {ACK, NACK}. Therefore, the number of the total bits of the HARQ-ACK feedback information of the CC1 is six. The total number of bits of the HARQ-ACK feedback information of the two CCs configured for the UE is seven which is obtained by adding one to six and is larger than four. According to the exemplary methods of the present invention, the following group bundling may be performed on the HARQ-ACK feedback information of the two CCs.

First, the spatial bundling is performed on the HARQ-ACK feedback information of the CC0 and CC1, the bundled HARQ-ACK feedback information of the CC0 is {ACK}, and the bundled HARQ-ACK feedback information of the CC1 is {DTX}, {ACK} and {NACK}. For example, {DTX, DTX}→{DTX}, {ACK, ACK}→{ACK} and {ACK, NACK}→{NACK}. The total number of the bits of the bundled HARQ-ACK feedback information of the CC0 and CC1 is four, and the time domain bundling is not needed to be performed. Thus, the CC0 generates one bit of HARQ-ACK feedback information. Accordingly, one PUCCH format 1a/1b resource is obtained with the index of the first CCE of the PDCCH on the CC0 or indicated by the ARI in the PUCCH. The CC1 generates three bits of the HARQ-ACK feedback information. Accordingly, three PUCCH format 1a/1b resources are obtained by the indexes nCCE of the first CCEs of the PDCCHs on the CC1, or indicated by the ARIs in the PDCCHs.

Thereafter, the HARQ-ACK feedback information which is processed with the spatial bundling is divided into two groups. The total number of bits of the HARQ-ACK feedback information in each group is two.

As shown in Table 20, an improved grouping method is forming a group with the HARQ-ACK feedback information of sub-frame 0 of the CC0 and the HARQ-ACK feedback information of sub-frame 2 of the CC1, and forming a group with the HARQ-ACK feedback information of sub-frame 0 of the CC1 and the HARQ-ACK feedback information of sub-frame 1 of the CC1.

TABLE 20
The constitution of the bits of the HARQ-ACK feedback information
HARQ-ACK(j)

| | |
|---|---|
| Group 0 | Group 1 |

| HARQ- | HARQ- | HARQ- | HARQ- |
|---|---|---|---|
| ACK(0) | ACK(1) | ACK(2) | ACK(3) |
| Sub-frame 0 | Sub-frame 2 | Sub-frame 0 | Sub-frame 1 |
| of the PCC | of the SCC | of the SCC | of the SCC |

The PUCCH resources used for transmitting the HARQ-ACK feedback information are shown in Table 21 below, wherein

PUCCH resource (0) is obtained by the index nCCE of the first CCE of the PDCCH of sub-frame 0 of the PCC,

PUCCH resource (1) is obtained by the index nCCE of the first CCE of the PDCCH of sub-frame 2 of the SCC, or indicated by the ARI in the PDCCH,

PUCCH resource (2) is obtained by the index nCCE of the first CCE of the PDCCH of sub-frame 0 of the SCC, or indicated by the ARI in the PDCCH, and

PUCCH resource (3) is obtained by the index nCCE of the first CCE of the PDCCH of sub-frame 1 of the SCC, or indicated by the ARI in the PDCCH.

TABLE 21
The constitution of the PUCCH resources
PUCCH resource (j)

| | |
|---|---|
| Group 0 | Group 1 |

| PUCCH | PUCCH | PUCCH | PUCCH |
|---|---|---|---|
| resource (0) | resource (1) | resource (2) | resource (3) |
| Sub-frame 0 | Sub-frame 2 | Sub-frame 0 | Sub-frame 1 |
| of the PCC | of the SCC | of the SCC | of the SCC |

It is assumed that the CC0 is the SCC, and the CC1 is the PCC. The constitution of the bits of the HARQ-ACK feedback information is shown in Table 22 below.

TABLE 22
The constitution of bits of the HARQ-ACK feedback information
HARQ-ACK(j)

| | |
|---|---|
| Group 0 | Group 1 |

| HARQ- | HARQ- | HARQ- | HARQ- |
|---|---|---|---|
| ACK(0) | ACK(1) | ACK(2) | ACK(3) |
| Sub-frame 0 | Sub-frame 1 | Sub-frame 0 | Sub-frame 2 |
| of the PCC | of the PCC | of the SCC | of the PCC |

The PUCCH resources used for transmitting the HARQ-ACK feedback information are shown in Table 23 below, wherein

PUCCH resource (0) is obtained by the index nCCE of the first CCE of the PDCCH of sub-frame 0 of the PCC,

PUCCH resource (1) is obtained by the index nCCE of the first CCE of the PDCCH of sub-frame 1 of the PCC,

PUCCH resource (2) is obtained by the index nCCE of the first CCE of the PDCCH of sub-frame 0 of the SCC, or indicated by the ARI in the PDCCH, and

PUCCH resource (3) is obtained by the index nCCE of the first CCE of the PDCCH of sub-frame 2 of the PCC.

TABLE 23
The constitution of the PUCCH resources
PUCCH resource (j)

| | |
|---|---|
| Group 0 | Group 1 |

| PUCCH | PUCCH | PUCCH | PUCCH |
|---|---|---|---|
| resource (0) | resource (1) | resource (2) | resource (3) |
| Sub-frame 0 | Sub-frame 1 | Sub-frame 0 | Sub-frame 2 |
| of the PCC | of the PCC | of the SCC | of the PCC |

Another improved grouping method is forming a group with the HARQ-ACK feedback information of a sub-frame, DAI of which is one of the CC0 and the HARQ-ACK feedback information of a sub-frame, DAI of which is three of the CC1, and forming a group with the HARQ-ACK feedback information of a sub-frame, DAI of which is one of the CC1 and the HARQ-ACK feedback information of a sub-frame, DAI of which is two of the CC1. It is assumed that the CC0 is the PCC and the CC1 is the SCC. Thereafter, the constitution of bits of the HARQ-ACK feedback information is shown in Table 24 below.

TABLE 24
The constitution of bits of the HARQ-ACK feedback information
HARQ-ACK(j)

| Group 0 | | Group 1 | |
|---|---|---|---|
| HARQ- | HARQ- | HARQ- | HARQ- |
| ACK(0) | ACK(1) | ACK(2) | ACK(3) |
| Sub-frame, | Sub-frame, | Sub-frame, | Sub-frame, |
| DAI of which | DAI of which | DAI of which | DAI of which |
| is one of | is three of | is one of | is two of |
| the PCC | the SCC | the SCC | the SCC |

The PUCCH resources used for transmitting the HARQ-ACK feedback information are shown in Table 25 below, wherein

PUCCH resource (0) is obtained by the index nCCE of the first CCE of the PDCCH of a sub-frame, DAI of which is one in the PCC,

PUCCH resource (1) is obtained by the index nCCE of the first CCE of the PDCCH of a sub-frame, DAI of which is three in the SCC, or indicated by the ARI in the PDCCH,

PUCCH resource (2) is obtained by the index nCCE of the first CCE of the PDCCH of a sub-frame, the DAI of which is one in the SCC, or indicated by the ARI in the PDCCH, and

PUCCH resource (3) is obtained by the index nCCE of the first CCE of the PDCCH of a sub-frame, the DAI of which is two in the SCC, or indicated by the ARI in the PDCCH.

TABLE 25
The constitution of the PUCCH resources
PUCCH resource (j)

| Group 0 | | Group 1 | |
|---|---|---|---|
| PUCCH | PUCCH | PUCCH | PUCCH |
| resource (0) | resource (1) | resource (2) | resource (3) |
| Sub-frame, | Sub-frame, | Sub-frame, | Sub-frame, |
| DAI of which | DAI of which | DAI of which | DAI of which |
| is one in | is three in | is one in | is two in |
| the PCC | the SCC | the SCC | the SCC |

It is assumed that the CC1 is the PCC, and the CC0 is the SCC. Thereafter, the constitution of the bits of the HARQ-ACK feedback information is shown in Table 26 below.

TABLE 26
The constitution of the bits of the HARQ-ACK feedback information
HARQ-ACK(j)

| Group 0 | | Group 1 | |
|---|---|---|---|
| HARQ- | HARQ- | HARQ- | HARQ- |
| ACK(0) | ACK(1) | ACK(2) | ACK(3) |
| Sub-frame, | Sub-frame, | Sub-frame, | Sub-frame, |
| DAI of which | DAI of which | DAI of which | DAI of which |
| is one in | is two in | is one in | is three in |
| the PCC | the PCC | the SCC | the PCC |

The PUCCH resources used for transmitting the HARQ-ACK feedback information are shown in Table 27 below, wherein

PUCCH resource (0) is obtained by the index nCCE of the first CCE of the PDCCH of a sub-frame, DAI of which is one in the PCC,

PUCCH resource (1) is obtained by the index nCCE of the first CCE of the PDCCH of a sub-frame, DAI of which is two in the PCC,

PUCCH resource (2) is obtained by the index nCCE of the first CCE of the PDCCH of a sub-frame, the DAI of which is one in the SCC, or indicated by the ARI in the PDCCH, and

PUCCH resource (3) is indicated by the PDCCH of a sub-frame, the DAI of which is three in the PCC.

TABLE 27
The constitution of the PUCCH resources
PUCCH resource (j)

| Group 0 | | Group 1 | |
|---|---|---|---|
| PUCCH | PUCCH | PUCCH | PUCCH |
| resource (0) | resource (1) | resource (2) | resource (3) |
| Sub-frame, | Sub-frame, | Sub-frame, | Sub-frame, |
| DAI of which | DAI of which | DAI of which | DAI of which |
| is one in | is two in | is one in | is three in |
| the PCC | the PCC | the SCC | the PCC |

The second situation is that in one HARQ-ACK feedback period, if the number of the bundling window of the CC0 is one, i.e., only one sub-frame, the CC0 is configured with the SIMO transmission. The HARQ-ACK feedback information of sub-frame 0 is {ACK}. Thus, the total number of the bit of the HARQ-ACK feedback information of the CC0 is one. The number of the bundling windows of the CC1 is four, and the CC1 is configured with the MIMO transmission. The HARQ-ACK feedback information of sub-frame 0, sub-frame 1, sub-frame 2 and sub-frame 3 is {DTX, DTX}, {ACK, ACK}, {ACK, NACK} and {ACK, NACK}. Thus, the total number of the bits of the HARQ-ACK feedback information of the CC1 is eight. The total number of the bits of the HARQ-ACK feedback information of the two CCs configured for the UE is nine which is obtained by adding one to eight and is larger than four. According to the exemplary method of the present invention, the following group bundling may be performed on the HARQ-ACK feedback information of the two CCs.

First, the spatial bundling is performed on the HARQ-ACK feedback information of the CC0 and CC1, the HARQ-ACK feedback information of the bundled CC0 is {ACK}, and the bundled HARQ-ACK feedback information of the CC1 is {DTX}, {ACK}, {NACK}, {NACK}. For example, {DTX, DTX}→{DTX}, {ACK, ACK}→{ACK}, {ACK, NACK}→{NACK}, {ACK, NACK}→{NACK}. The total number of the bits of the HARQ-ACK feedback information of the bundled CC0 and CC1 is five. The five bits of HARQ-ACK feedback information need to be divided into two groups first. Thereafter, the time domain bundling is performed on the bundled HARQ-ACK feedback information, the total number of the bits of which is larger than two.

An improved grouping method is forming a group with the HARQ-ACK feedback information of sub-frame 0 of the CC0 and the HARQ-ACK feedback information of sub-frame 3 of the CC1, and forming a group with the HARQ-ACK feedback information of sub-frame 0 of the CC1, the HARQ-ACK feedback information of sub-frame 1 of the CC1 and the HARQ-ACK feedback information of sub-frame 2 of the CC1. Thereafter, the time domain bundling is performed on the group of the HARQ-ACK feedback information of the three bits to generate two bits of the HARQ-ACK feedback information, which is denoted as HARQ-ACK(0) time_bundling and HARQ-ACK(1) time_bundling. It is assumed that the CC0 is the PCC and the CC1 is the SCC. The constitution of the bits of the HARQ-ACK feedback information is shown in Table 28 below.

TABLE 28
The constitution of the bits of the HARQ-ACK feedback information
HARQ-ACK(j)

| Group 0 | | Group 1 | |
|---|---|---|---|
| HARQ- | HARQ- | HARQ- | HARQ- |
| ACK(0) | ACK(1) | ACK(2) | ACK(3) |
| Sub-frame 0 | Sub-frame 3 | HARQ-ACK(0) | HARQ-ACK(1) |
| of the PCC | of the SCC | time_bundling | time_bundling |
| | | of the SCC | of the SCC |

The PUCCH resources used for transmitting the HARQ-ACK feedback information are shown in Table 29 below, wherein

PUCCH resource (0) is obtained by the index nCCE of the first CCE of the PDCCH of sub-frame 0 of the PCC,

PUCCH resource (1) is obtained by the index nCCE of the first CCE of the PDCCH of sub-frame 3 of the SCC, or indicated by the ARI in the PDCCH,

PUCCH resource (2) is obtained by the index nCCE of the first CCE of the PDCCH of a sub-frame, the DAI of which is one in sub-frame 0, sub-frame 1 and sub-frame 2 of the SCC, or indicated by the ARI in the PDCCH, and

PUCCH resource (3) is obtained by the index nCCE of the first CCE of the PDCCH of a sub-frame, the DAI of which is two in sub-frame 0, sub-frame 1 and sub-frame 2 of the SCC, or indicated by the ARI in the PDCCH.

TABLE 29
The constitution of the PUCCH resources
PUCCH resource (j)

| Group 0 | | Group 1 | |
|---|---|---|---|
| PUCCH | PUCCH | PUCCH | PUCCH |
| resource (0) | resource (1) | resource (2) | resource (3) |
| Sub-frame 0 | Sub-frame 3 | Sub-frame, the DAI | Sub-frame, the DAI |
| of the PCC | of the SCC | of which is one in | of which is two in |
| | | sub-frame 0, sub- | sub-frame 0, sub- |
| | | frame 1 and sub- | frame 1 and sub- |
| | | frame 2 of the SCC | frame 2 of the SCC |

It is assumed that the CC1 is the PCC, and the CC0 is the SCC. Thereafter, the constitution of the HARQ-ACK feedback information is shown in Table 30 below.

TABLE 30
The constitution of the bits of the HARQ-ACK feedback information
HARQ-ACK(j)

| Group 0 | | Group 1 | |
|---|---|---|---|
| HARQ- | HARQ- | HARQ- | HARQ- |
| ACK(0) | ACK(1) | ACK(2) | ACK(3) |
| HARQ-ACK(0) | HARQ-ACK(1) | Sub-frame 0 | Sub-frame 3 |
| time_bundling | time_bundling | of the SCC | of the PCC |
| of the PCC | of the PCC | | |

The PUCCH resources used for transmitting the HARQ-ACK feedback information are shown in Table 31 below, wherein

PUCCH resource (0) is obtained by the index nCCE of the first CCE of the PDCCH of a sub-frame, the DAI of which is one in sub-frame 0, sub-frame 1 and sub-frame 2 of the PCC,

PUCCH resource (1) is obtained by the index nCCE of the first CCE of the PDCCH of a sub-frame, the DAI of which is two in sub-frame 0, sub-frame 1 and sub-frame 2 of the PCC,

PUCCH resource (2) is obtained by the index nCCE of the first CCE of the PDCCH of sub-frame 0 of the SCC, or indicated by the ARI in the PDCCH, and

PUCCH resource (3) is obtained by the index nCCE of the first CCE of the PDCCH of sub-frame 3 of the PCC.

TABLE 31
The constitution of the PUCCH resources
PUCCH resource (j)

| Group 0 | | Group 1 | |
|---|---|---|---|
| PUCCH | PUCCH | PUCCH | PUCCH |
| resource (0) | resource (1) | resource (2) | resoruce (3) |
| Sub-frame, the DAI | Sub-frame, the DAI | Sub-frame 0 | Sub-frame 3 |
| of which is one in | of which is two in | of the SCC | of the PCC |
| sub-frame 0, sub- | sub-frame 0, sub- | | |
| frame 1 and sub- | frame 1 and sub- | | |
| frame 2 of the PCC | frame 2 of the PCC | | |

Another improved selecting and grouping method is forming a group with the HARQ-ACK feedback information of a sub-frame, the DAI of which is one in the CC0 and the HARQ-ACK feedback information of a sub-frame, the DAI of which is four in the CC1, and forming a group with the HARQ-ACK feedback information of a sub-frame, the DAI of which is one in the CC1, the HARQ-ACK feedback information of a sub-frame, the DAI of which is two in the CC1 and the HARQ-ACK feedback information of a sub-frame, the DAI of which is three in the CC1. Thereafter, the time domain bundling is performed on the group of the HARQ-ACK feedback information of the three bits to generate two bits of the HARQ-ACK feedback information, which is denoted as HARQ-ACK(0) time_bundling and HARQ-ACK(1) time_bundling.

It is assumed that the CC0 is the PCC, and the CC1 is the SCC. The constitution of the bits of the HARQ-ACK feedback information is shown in Table 32 below.

TABLE 32
The constitution of the bits of the HARQ-ACK feedback information
HARQ-ACK(j)

| Group 0 | | Group 1 | |
|---|---|---|---|
| HARQ- | HARQ- | HARQ- | HARQ- |
| ACK(0) | ACK(1) | ACK(2) | ACK(3) |
| Sub-frame, | Sub-frame, | HARQ-ACK(0) | HARQ-ACK(1) |
| DAI of which | DAI of which | time_bundling | time_bundling |
| is one in | is four in | of the SCC | of the SCC |
| the PCC | the SCC | | |

The PUCCH resources used for transmitting the HARQ-ACK feedback information are shown in Table 33 below, wherein

PUCCH resource (0) is obtained by the index nCCE of the first CCE of the PDCCH of a sub-frame, DAI of which is one in the PCC,

PUCCH resource (1) is obtained by the index nCCE of the first CCE of the PDCCH of a sub-frame, DAI of which is four in the SCC, or indicated by the ARI in the PDCCH,

PUCCH resource (2) is obtained by the index nCCE of the first CCE of the PDCCH of a sub-frame, the DAI of which is one in the SCC, or indicated by the ARI in the PDCCH, and

PUCCH resource (3) is indicated by the index nCCE of the first CCE of the PDCCH of a sub-frame, the DAI of which is two in the SCC, or indicated by the ARI in the PDCCH.

### Table 33

TABLE 33
The constitution of the PUCCH resources
PUCCH resource (j)

| Group 0 | | Group 1 | |
|---|---|---|---|
| PUCCH | PUCCH | PUCCH | PUCCH |
| resource (0) | resource (1) | resource (2) | resource (3) |
| Sub-frame, | Sub-frame, | Sub-frame, | Sub-frame, |
| DAI of which | DAI of which | DAI of which | DAI of which |
| is one in | is four in | is one in | is two in |
| the PCC | the SCC | the SCC | the SCC |

It is assumed that the CC1 is the PCC, and the CC0 is the SCC. The constitution of the HARQ-ACK feedback information is shown in Table 34 below.

TABLE 34
The constitution of the bits of the HARQ-ACK feedback information
HARQ-ACK(j)

| Group 0 | | Group 1 | |
|---|---|---|---|
| HARQ- | HARQ- | HARQ- | HARQ- |
| ACK(0) | ACK(1) | ACK(2) | ACK(3) |
| HARQ-ACK(0) | HARQ-ACK(1) | Sub-frame, | Sub-frame, |
| time_bundling | time_bundling | DAI of which | DAI of which |
| of the PCC | of the PCC | is one in | is four in |
| | | the SCC | the PCC |

The PUCCH resources used for transmitting the HARQ-ACK feedback information are shown in Table 35 below, wherein

PUCCH resource (0) is obtained by the index nCCE of the first CCE of the PDCCH of a sub-frame, DAI of which is one in the PCC,

PUCCH resource (1) is obtained by the index nCCE of the first CCE of the PDCCH of a sub-frame, DAI of which is two in the PCC,

PUCCH resource (2) is obtained by the index nCCE of the first CCE of the PDCCH of a sub-frame, the DAI of which is one in the SCC, or indicated by the ARI in the PDCCH, and

PUCCH resource (3) is indicated by the index nCCE of the first CCE of the PDCCH of a sub-frame, the DAI of which is four in the PCC.

TABLE 35
The constitution of the PUCCH resources
PUCCH resource (j)

| Group 0 | | Group 1 | |
|---|---|---|---|
| PUCCH | PUCCH | PUCCH | PUCCH |
| resource (0) | resource (1) | resource (2) | resource (3) |
| Sub-frame, | Sub-frame, | Sub-frame, | Sub-frame, |
| DAI of which | DAI of which | DAI of which | DAI of which |
| is one in | is two in | is one in | is four in |
| the PCC | the PCC | the SCC | the PCC |

Table 35 illustrates the situation that one group of the HARQ-ACK feedback information in the two groups before the bundling is three bits and four bits. According to an exemplary embodiment of the present invention, one HARQ-ACK feedback information group before the bundling may be five bits, six bits, seven bits, eight bits or nine bits, and may be processed accordingly.

Except for the above exemplary methods of the present invention, another exemplary implementation of the time domain bundling adopts the Rel-8 Time bundling method (i.e., a time domain bundling method performed on the HARQ-ACK feedback information with the HARQ-ACK and SR appears together). In an exemplary implementation, other bundling methods of the time domain may be adopted.

In the third exemplary embodiment of the present invention, the principle of the group bundling is described below.

If the total number of bits of the HARQ-ACK feedback information of the two CCs configured for the UE is larger than four, the spatial bundling is performed on the HARQ-ACK feedback information of all the sub-frames on the two CCs first.

Thereafter, at most two bits of the HARQ-ACK feedback information are independently generated according to the respective bundling window of the two CCs and the synthesized bits of the HARQ-ACK feedback information of the two CCs are obtained. The UE performs the transmission of the PUCCH format 1b of the channel selection according to the generated bits of the HARQ-ACK feedback information.

The above exemplary method for independently generating at most two bits is described below.

If the number of the bundling window on a certain CC is one, the time domain bundling needs not to be performed, and one bit of the HARQ-ACK feedback information is generated.

If the number of the bundling windows on a certain CC is two, the time domain bundling needs not to be performed, and two bits of the HARQ-ACK feedback information is generated.

If the number of the bundling windows on a certain CC is larger than two, the time domain bundling needs to be performed, and two bits of the HARQ-ACK feedback information are generated according to the time domain bundling.

Specifically, the above exemplary methods may be implemented through the following modes.

The exemplary methods of the present invention target the situation that the TDD UL/DL configurations of the two CCs are different. For example, the bundling windows of the two CCs in a HARQ-ACK feedback period are different.

As for a CC, when the number of the bundling window is one, the time domain bundling needs not to be performed. When the bundling window is configured with the SIMO transmission, a piece of HARQ-ACK feedback information HARQ-ACK(0) is generated. The HARQ-ACK feedback information may be {ACK} or {NACK/DTX}.

If the MIMO transmission is adopted, a piece of HARQ-ACK feedback information HARQ-ACK(0) is generated through the spatial bundling. The HARQ-ACK feedback information may be {ACK} or {NACK/DTX}.

As for a CC, when the number of the bundling windows is two, the time domain bundling needs not to be performed. If the CC is configured with the SIMO transmission, two bits of the HARQ-ACK feedback information are obtained. If the CC is configured with the MIMO transmission, the spatial bundling needs to be performed to generate two bits of the HARQ-ACK feedback information. According to this exemplary method, the obtained HARQ-ACK feedback information {HARQ-ACK(0), HARQ-ACK(1)} is {ACK, ACK}, {ACK, NACK/DTX}, {NACK/DTX, ACK} or {NACK/DTX, NACK/DTX}.

As for a CC, when the number of the bundling windows is three, the time domain bundling needs to be performed. If the CC is configured with the SIMO transmission, two bits of the HARQ-ACK feedback information are obtained through the time domain bundling. If the CC is configured with the MIMO transmission, the spatial bundling needs to be performed first, and the time domain bundling or compression is performed thereafter to generate two bits of the HARQ-ACK feedback information. According to an exemplary implementation of the present invention, two bits of the HARQ-ACK feedback information {HARQ-ACK(0), HARQ-ACK(1)} including {ACK, ACK}, {ACK, NACK/DTX}, {NACK/DTX, ACK} or {NACK/DTX, NACK/DTX} may be obtained according to the time domain bundling or compression mode as shown in Table 3 above.

As for a CC, when the number of the bundling windows is four, the time domain bundling needs to be performed. If the CC is configured with the SIMO transmission, two bits of the HARQ-ACK feedback information are obtained through the time domain bundling. If the CC is configured with the MIMO transmission, the spatial bundling needs to be performed first, and the time domain bundling or compression is performed thereafter to generate two bits of the HARQ-ACK feedback information at last. According to an exemplary implementation of the present invention, two bits of the HARQ-ACK feedback information {HARQ-ACK(0), HARQ-ACK(1)} including {ACK, ACK}, {ACK, NACK/DTX}, {NACK/DTX, ACK} or {NACK/DTX, NACK/DTX} may be obtained according to the time domain bundling or compression mode as shown in Table 4 above.

Thus, the HARQ-ACK feedback information of the two CCs is combined, and the HARQ-ACK information is fed back with a channel selection method.

For instance, when the CC0 is configured with the SIMO transmission or MIMO transmission, the HARQ-ACK feedback information on the CC0 is {ACK} or {NACK/DTX}. After performing the bundling or compression processing on the HARQ-ACK feedback information of the CC1, two pieces of the HARQ-ACK feedback information {HARQ-ACK(0), HARQ-ACK(1)} including {ACK, ACK}, {ACK, NACK/DTX}, {NACK/DTX, ACK} or {NACK/DTX, NACK/DTX} is obtained. Thus, the HARQ-ACK feedback information of the CC1 may be combined with the HARQ-ACK feedback information of another CC to obtain the feedback mapping table of the PUCCH format 1b of the channel selection as shown in Table 5 above.

Some exemplary embodiments of the present invention are provided below to further describe the third exemplary embodiment of the present invention for obtaining the feedback mapping table of the PUCCH format 1b of the channel selection.

### Exemplary Embodiment Thirteen

In this exemplary embodiment of the present invention, it is assumed that the CC0 is the Scell, and the number of the bundling window is one, while the CC1 is the Pcell, and the number of the bundling windows is three. If the CC0 is configured with the SIMO transmission, the CC0 may obtain one bit of the HARQ-ACK feedback information. If the CC0 is configured with the MIMO transmission, the CC0 may obtain one bit of the HARQ-ACK feedback information through the spatial bundling. Since the number of the bundling windows of the CC1 is three, if the CC1 is configured with the MIMO transmission, the spatial bundling needs to be performed first. Regardless of the MIMO transmission or the SIMO transmission, the CC1 may obtain three bits of HARQ-ACK feedback information. The feedback mapping table of the PUCCH format 1b of the channel selection may be obtained with reference to Table 3 and Table 5 above. The feedback mapping table is shown in Table 8 above.

### Exemplary Embodiment Fourteen

In this exemplary embodiment of the present invention, it is assumed that the CC0 is the Scell, and the number of the bundling window is one, while the CC1 is the Pcell, and the number of the bundling windows is four. If the CC0 is configured with the SIMO transmission, the CC0 may obtain one bit of the HARQ-ACK feedback information. If the CC0 is configured with the MIMO transmission, the CC0 may obtain one bit of the HARQ-ACK feedback information through the spatial bundling. Since the number of the bundling windows of the CC1 is four, if the CC1 is configured with the MIMO transmission, the spatial bundling needs to be performed first. Regardless of the MIMO transmission or the SIMO transmission, the CC1 may obtain four bits of HARQ-ACK feedback information. The feedback mapping table of the PUCCH format 1b of the channel selection may be obtained with reference to Table 4 and Table 5 above. The feedback mapping table is shown in Table 9 above.

The resource mapping method is described below.

If the number of the bundling window on a certain CC is one, the PUCCH resource is mapped from the index nCCE of the first CCE which is used by the PDCCH scheduling the PDSCH, or indicated by the ARI in the PDCCH scheduling the PDSCH. Thereafter, only one PUCCH format 1a/1b resource is required.

If the number of the bundling windows on a certain CC is two, the PUCCH resources are mapped from the indexes nCCE of the first CCEs which are used by the PDCCHs scheduling the PDSCHs of sub-frame 1 and sub-frame 2, or indicated by the ARIs in the PDCCHs scheduling the PDSCHs. Thereafter, two PUCCH format 1a/1b resources are required.

If the number of the bundling windows on a certain CC is larger than two, the PUCCH resources are mapped from the indexes nCCE of the first CCEs which are used by the PDCCHs scheduling the PDSCHs, DAIs of which equal to one and two, or indicated by the ARIs in the PDCCHs scheduling the PDSCHs. Thereafter, two PUCCH format 1a/1b resources are required. When there is an SPS service, the PUCCH format 1a/1b resource of the semi-static allocation of the SPS service is the first alternative PUCCH format 1a/1b resource. While the PUCCH format 1a/1b resource got by the index of the first CCE occupied by the PDCCH, the DAI of which is one, is the second PUCCH format 1a/1b resource.

Some exemplary embodiments of the present invention are provided below to further describe the third exemplary embodiment of the present invention for obtaining the feedback mapping table of the PUCCH format 1b of the channel selection.

### Exemplary Embodiment Fifteen

If the CC0 is the Pcell, the number of the bundling window is one, and the CC0 is configured with the SIMO transmission or MIMO transmission. One PUCCH resource of the CC0 is mapped out, and the PUCCH resource of the CC0 is mapped from the index nCCE of the minimum CCE which is used by the PDCCH scheduling the PDSCH. While the CC1 is the Scell, the number of the bundling windows is two and two PUCCH resources are required in the CC1. As shown in Table 36 below, if the CC1 is scheduled by the PDCCH of the Pcell CC0 crossing cells, the two PUCCH resources of the CC1 are mapped from the indexes of the minimum CCEs which are used by the PDCCHs of sub-frame 0 and sub-frame 1 of the Pcell CC0. The PDCCHs schedule the PDSCHs of the CC1 crossing cells.

TABLE 36
PUCCH resource (j)

| | |
|---|---|
| CC1 | CC0 |
| Scell | Pcell |

| | PUCCH | PUCCH | PUCCH |
|---|---|---|---|
| | resource (0) | resource (1) | resource (2) |
| Cross- | Index nCCE of | Index nCCE of | Index nCCE of |
| carrier | the first CCE | the first CCE | the first CCE |
| scheduling | of sub-frame 0 | of sub-frame 1 | |
| Non cross- | ARI | ARI | Index nCCE of |
| carrier | | | the first CCE |
| scheduling | | | |

### Exemplary Embodiment Sixteen

If the CC0 is the Pcell, the number of the bundling window is one, and the SIMO transmission or MIMO transmission is adopted. While the CC1 is the Scell, the number of the bundling windows is two. Thereafter, the PUCCH resource mapping table is shown in Table 37 below.

TABLE 37
PUCCH resource (j)

| | |
|---|---|
| CC1 | CC0 |
| Scell | Pcell |

| | PUCCH | PUCCH | PUCCH |
|---|---|---|---|
| | resource (0) | resource (1) | resource (2) |
| Cross- | Index nCCE of | Index nCCE of | Index nCCE |
| carrier | the first CCE | the first CCE | of the |
| scheduling | of a sub-frame, | of a sub-frame, | first CCE |
| | DAI of which | DAI of which | |
| | is one | is two | |
| Non cross- | ARI | ARI | Index nCCE |
| carrier | | | of the |
| scheduling | | | first CCE |

### Exemplary Embodiment Seventeen

If the CC0 is the Scell, the number of the bundling window is one, and the SIMO transmission or MIMO transmission is adopted. While the CC1 is the Pcell, the number of the bundling windows is two. Thereafter, the PUCCH resource mapping table is shown in Table 38 below.

TABLE 38
PUCCH resource (j)

| | |
|---|---|
| CC1 | CC0 |
| Pcell | Scell |

| | PUCCH | PUCCH | PUCCH |
|---|---|---|---|
| | resource (0) | resource (1) | resource (2) |
| Cross- | Index nCCE of | Index nCCE of | Index nCCE |
| carrier | the first CCE | the first CCE | of the |
| scheduling | of sub-frame 0 | of sub-frame 1 | first CCE |
| Non cross- | Index nCCE of | Index nCCE of | ARI |
| carrier | the first CCE | the first CCE | |
| scheduling | of sub-frame 0 | of sub-frame 1 | |

### Exemplary Embodiment Eighteen

If the CC0 is the Scell, the number of the bundling window is one, and the SIMO transmission or MIMO transmission is adopted. While the CC1 is the Pcell, the number of the bundling windows is larger than two. Thereafter, the PUCCH resource mapping table is shown in Table 39 below.

TABLE 39
PUCCH resource (j)

| | |
|---|---|
| CC1 | CC0 |
| Pcell | Scell |

| | PUCCH | PUCCH | PUCCH |
|---|---|---|---|
| | resource (0) | resource (1) | resource (2) |
| Cross- | Index nCCE | Index nCCE | Index nCCE |
| carrier | of the first | of the first | of the first |
| scheduling | CCE of a sub- | CCE of a sub- | CCE of a sub- |
| | frame, DAI of | frame, DAI of | frame, DAI of |
| | which is one | which is two | which is one |
| Non cross- | Index nCCE | Index nCCE | ARI |
| carrier | of the first | of the first | |
| scheduling | CCE of a sub- | CCE of a sub- | |
| | frame, DAI of | frame, DAI of | |
| | which is one | which is two | |

Except for the above exemplary methods of the present invention, another exemplary implementation of the spatial bundling adopts a Rel-8 Time bundling method (i.e., a time domain bundling method performed on the HARQ-ACK feedback information with the HARQ-ACK and SR). Other time domain bundling methods may be adopted in an exemplary implementation.

In step 303, the UE transmits the bundled HARQ-ACK feedback to the base station on the PUCCH channel resources adopting the PUCCH format 1b of the channel selection, according to the PUCCH channel resource which is mapped from the HARQ-ACK feedback information and modulation symbols. The HARQ-ACK feedback information is obtained according to the group bundling.

The HARQ-ACK feedback information after the group bundling in this block is transmitted on the PCCs. There are two situations:

The first situation: The PUCCH may be transmitted on the PCC, and may also be transmitted on the SCC. However, the HARQ-ACK feedback information generated with the exemplary methods of the present invention is only transmitted on the PUCCH of the PCC. Other HARQ-ACK feedback information feedback information may be transmitted on the PUCCH of the SCC.

The second situation: All the HARQ-ACK feedback information may only be transmitted on the PUCCH of the PCC.

The exemplary methods of the present invention for transmitting the HARQ-ACK feedback information have been described above. The exemplary methods of the present invention are further described with respect to two more exemplary embodiments of the present invention accompanying with FIGS. 4 through 6.

In exemplary embodiments of the present invention, as for the situation that the UL and DL configurations of the two CCs are different, in order to come along with the LTE-A, the timing relationship of the HARQ-ACK of each CC is not changed. If a certain sub-frame on each of the two CCs is the UL sub-frame, the HARQ-ACK feedback information of the two CCs is transmitted only on the UL sub-frame of the PCC.

### Exemplary Embodiment Nineteen

This exemplary embodiment of the present invention adopts the group bundling principle in the above first exemplary embodiment.

FIG. 4 is a schematic diagram illustrating a method for transmitting Hybrid Automatic Repeat reQuest-ACKnowledgement (HARQ-ACK) feedback information in a CA according to an exemplary embodiment of the present invention.

Referring to FIG. 4, it is assumed that the UL/DL configurations of the two CCs belonging to the same CA are different, and the number and location of the HARQ-ACK bundling window of each CC is different.

The sub-frames 0, 1, 5 and 6 of the PCC are configured as the DL sub-frames, the sub-frames 2 through 4, and sub-frames 7 through 9 of the PCC are configured as the UL sub-frames, and the transmission mode of the PDSCH of the PCC is the SIMO transmission mode.

The sub-frames 0, 1 and sub-frames 5 through 9 of the SCC are configured as the DL sub-frames, the sub-frames 2 through 4 of the SCC are configured as the UL sub-frames, and the transmission mode of the PDSCH of the SCC is the MIMO transmission mode.

According to the existing timing relationship of the HARQ-ACK of the PCC and the SCC, a HARQ-ACK bundling window of the PCC includes sub-frame 6 (i.e., the location of the sub-frame 6 which corresponds to a line, at which the PCC locates are shown with slash boxes in FIG. 4). The HARQ-ACK feedback information of the PCC is one bit.

A HARQ-ACK bundling window of the SCC includes sub-frames 1, 5 and 6 (i.e., the locations of the sub-frames 1, 5 and 6 which correspond to a line, at which the SCC locates, are shown with slash boxes in FIG. 4).

The HARQ-ACK feedback information of the sub-frame 6 of the PCC and the sub-frames 1, 5 and 6 of the SCC is transmitted in sub-frame 2 (i.e., the location of the sub-frame 2 which corresponds to a line, at which the PCC locates is shown with a small box in FIG. 4) of a next radio frame of the PCC.

It is assumed that the HARQ-ACK feedback information of sub-frame 6 of the PCC is {ACK}. Thereafter, the total number of the bit of the HARQ-ACK feedback information of the PCC is one, which is not larger than two. Accordingly, the spatial bundling or the time domain bundling is not needed. While the number of the bundling windows of the SCC is three, the SCC is configured with the MIMO transmission. The HARQ-ACK feedback information of sub-frames 1, 5 and 6 of the SCC is {DTX, DTX}, {ACK, ACK} and {ACK, NACK} respectively. Thus, the total number of the bits of the HARQ-ACK feedback information of the SCC is six, which is larger than two. The spatial bundling is performed on the HARQ-ACK feedback information of the SCC first, and the bundled HARQ-ACK feedback information is {DTX}, {ACK} and {NACK}, i.e., {DTX, DTX}→{DTX}, {ACK, ACK}→{ACK}, {ACK, NACK}→{NACK}. The total number of the bits of the bundled HARQ-ACK feedback information is three, which is still larger than two. Therefore, the time domain bundling is needed. The time domain bundling is performed on the HARQ-ACK feedback information of the SCC after the spatial bundling. After the spatial bundling and time domain bundling, the information number of the HARQ-ACK of the SCC becomes two bits. The spatial bundling method is performed according to the time domain bundling methods as shown in Tables 3 and 4, and the PUCCH resources are obtained according to Rel-10.

### Exemplary Embodiment Twenty

This exemplary embodiment of the present invention adopts the group bundling principle in the above second exemplary embodiment.

Referring to FIG. 4, a group of corresponding HARQ-ACK bundling windows are the HARQ-ACK bundling window 6 of the PCC and the HARQ-ACK bundling windows 1, 5 and 6 of the SCC. The HARQ-ACK feedback information is transmitted in sub-frame 2 of the next radio frame of the PCC. If the transmission mode of the PCC is the SIMO transmission mode, the PCC provides one bit of the HARQ-ACK feedback information and one PUCCH format 1a/1b resource is accordingly needed. If the transmission mode of the HARQ-ACK bundling windows 1, 5 and 6 of the SCC is the SIMO transmission mode, there will be three bits of the HARQ-ACK feedback information. If the transmission mode of the HARQ-ACK bundling windows 1, 5 and 6 of the SCC is the MIMO transmission mode, there will be six bits of the HARQ-ACK feedback information. Thereafter, the spatial compression needs to be performed first to make the HARQ-ACK feedback information of the SCC become three bits, and three PUCCH format 1a/1b resources are accordingly needed. Thereafter, sub-frame 0 of the PCC and a sub-frame, DAI of which is three of the SCC are taken as a group, and a sub-frame, the DAI of which is one and a sub-frame, the DAI of which is two in the SCC are taken as a group. Two groups of four bits of the HARQ-ACK feedback information are formed. Thereafter, the mapping and transmission is performed according to the PUCCH format 1b of the channel selection as shown in Tables 3 and 4.

In the above three exemplary embodiments, the HARQ-ACK information is processed according to the number of the bundling windows of each CC. Since the number of the bundling windows of the two CCs may be different, the processing methods performed on each CC are different. This scheme applies to the various exemplary methods for determining the bundling windows of the Pcell and Scell as described above. The fourth exemplary embodiment of the present invention processes the HARQ-ACK information of the two CCs according to the larger bundling window of the two CCs. In the existing LTE Rel-10 specification, the channel selection mapping table when the number of the bundling windows of the two CCs is the same has been defined. The fourth exemplary embodiment of the present invention is described below.

It is assumed that M0 and M1 is the respective number of the bundling windows of the CC0 and CC1. In the process of using M0 and M1, the value of the larger window obtained by a formula, M=max (M0, M1) is taken as a reference value of the bundling windows of the two CCs. For example, it is assumed that values of both bundling windows of the two CCs are M, and the HARQ-ACK information of the two CCs is fed back according to the feedback mapping table of the PUCCH format 1b as shown in Tables X-1 through X-6 in the specification of LTE Rel-10.

Table X-1 is used for the situation that M=1, and the sum of the number of the HARQ-ACK bits of the two CCs is two.

Table X-2 is used for the situation that M=1, and the number of the sum of the HARQ-ACK bits of the two CCs is three.

Table X-3 is used for the situation that M=1, and the number of the sum of the HARQ-ACK bits of the two CCs is four.

Table X-4 is used for the situation that M=2.

Table X-5 is used for the situation that M=3.

Table X-6 is used for the situation that M=4.

According to this exemplary method, a sub-frame in a bundling window, the number of which is M on a CC is a UL sub-frame, the UE processes the HARQ-ACK information of the sub-frame of the CC as the DTX when feeding back the HARQ-ACK information using the following feedback mapping table of the PUCCH format 1b.

TABLE X-1
(M = 1, A = 2)

| HARQ-ACK(0), HARQ-ACK(1) | n_{PUCCH}⁽¹⁾ | b(0)b(1) |
|---|---|---|
| ACK, ACK | n_{PUCCH, 1}⁽¹⁾ | 1, 0 |
| ACK, NACK/DTX | n_{PUCCH, 0}⁽¹⁾ | 1, 1 |
| NACK/DTX, ACK | n_{PUCCH, 1}⁽¹⁾ | 0, 1 |
| NACK, NACK/DTX | n_{PUCCH, 0}⁽¹⁾ | 0, 0 |

| | |
|---|---|
| DTX, NACK/DTX | No Transmission |

TABLE X-2
(M = 1, A = 3)

| HARQ-ACK(0), HARQ-ACK(1), | | |
|---|---|---|
| HARQ-ACK(2) | n_{PUCCH}⁽¹⁾ | b(0)b(1) |
| ACK, ACK, ACK | n_{PUCCH, 2}⁽¹⁾ | 1, 1 |
| ACK, ACK, NACK/DTX | n_{PUCCH, 1}⁽¹⁾ | 1, 0 |
| ACK, NACK/DTX, ACK | n_{PUCCH, 2}⁽¹⁾ | 1, 0 |
| ACK, NACK/DTX, NACK/DTX | n_{PUCCH, 0}⁽¹⁾ | 1, 1 |
| NACK/DTX, ACK, ACK | n_{PUCCH, 2}⁽¹⁾ | 0, 1 |
| NACK/DTX, ACK, NACK/DTX | n_{PUCCH, 1}⁽¹⁾ | 0, 1 |
| NACK/DTX, NACK/DTX, ACK | n_{PUCCH, 2}⁽¹⁾ | 0, 0 |
| NACK, NACK/DTX, NACK/DTX | n_{PUCCH, 0}⁽¹⁾ | 0, 0 |

| | |
|---|---|
| DTX, NACK/DTX, NACK/DTX | No Transmission |

TABLE X-3
(M = 1, A = 4)

| HARQ-ACK(0), HARQ-ACK(1), | | |
|---|---|---|
| HARQ-ACK(2), HARQ-ACK(3) | n_{PUCCH}⁽¹⁾ | b(0)b(1) |
| ACK, ACK, ACK, ACK | n_{PUCCH, 1}⁽¹⁾ | 1, 1 |
| ACK, ACK, ACK, NACK/DTX | n_{PUCCH, 2}⁽¹⁾ | 1, 1 |
| ACK, ACK, NACK/DTX, ACK | n_{PUCCH, 0}⁽¹⁾ | 1, 0 |
| ACK, ACK, NACK/DTX, NACK/DTX | n_{PUCCH, 1}⁽¹⁾ | 1, 0 |
| ACK, NACK/DTX, ACK, ACK | n_{PUCCH, 3}⁽¹⁾ | 1, 1 |
| ACK, NACK/DTX, ACK, NACK/DTX | n_{PUCCH, 2}⁽¹⁾ | 1, 0 |
| ACK, NACK/DTX, NACK/DTX, ACK | n_{PUCCH, 0}⁽¹⁾ | 0, 1 |
| ACK, NACK/DTX, NACK/DTX, NACK/DTX | n_{PUCCH, 0}⁽¹⁾ | 1, 1 |
| NACK/DTX, ACK, ACK, ACK | n_{PUCCH, 1}⁽¹⁾ | 0, 0 |
| NACK/DTX, ACK, ACK, NACK/DTX | n_{PUCCH, 2}⁽¹⁾ | 0, 1 |
| NACK/DTX, ACK, NACK/DTX, ACK | n_{PUCCH, 3}⁽¹⁾ | 1, 0 |
| NACK/DTX, ACK, NACK/DTX, NACK/DTX | n_{PUCCH, 1}⁽¹⁾ | 0, 1 |
| NACK/DTX, NACK/DTX, ACK, ACK | n_{PUCCH, 3}⁽¹⁾ | 0, 1 |
| NACK/DTX, NACK/DTX, ACK, NACK/DTX | n_{PUCCH, 2}⁽¹⁾ | 0, 0 |
| NACK/DTX, NACK/DTX, NACK/DTX, ACK | n_{PUCCH, 3}⁽¹⁾ | 0, 0 |
| NACK, NACK/DTX, NACK/DTX, NACK/DTX | n_{PUCCH, 0}⁽¹⁾ | 0, 0 |

| | |
|---|---|
| DTX, NACK/DTX, NACK/DTX, NACK/DTX | No Transmission |

TABLE X-4
(M = 2)

| HARQ-ACK(0), HARQ-ACK(1), | | |
|---|---|---|
| HARQ-ACK(2), HARQ-ACK(3) | n_{PUCCH}⁽¹⁾ | b(0)b(1) |
| ACK, ACK, ACK, ACK | n_{PUCCH, 1}⁽¹⁾ | 1, 1 |
| ACK, ACK, ACK, NACK/DTX | n_{PUCCH, 2}⁽¹⁾ | 1, 1 |
| ACK, ACK, NACK/DTX, ACK | n_{PUCCH, 0}⁽¹⁾ | 1, 0 |
| ACK, ACK, NACK/DTX, NACK/DTX | n_{PUCCH, 1}⁽¹⁾ | 1, 0 |
| ACK, NACK/DTX, ACK, ACK | n_{PUCCH, 3}⁽¹⁾ | 1, 1 |
| ACK, NACK/DTX, ACK, NACK/DTX | n_{PUCCH, 2}⁽¹⁾ | 1, 0 |
| ACK, NACK/DTX, NACK/DTX, ACK | n_{PUCCH, 0}⁽¹⁾ | 0, 1 |
| ACK, NACK/DTX, NACK/DTX, NACK/DTX | n_{PUCCH, 0}⁽¹⁾ | 1, 1 |
| NACK/DTX, ACK, ACK, ACK | n_{PUCCH, 1}⁽¹⁾ | 0, 0 |
| NACK/DTX, ACK, ACK, NACK/DTX | n_{PUCCH, 2}⁽¹⁾ | 0, 1 |
| NACK/DTX, ACK, NACK/DTX, ACK | n_{PUCCH, 3}⁽¹⁾ | 1, 0 |
| NACK/DTX, ACK, NACK/DTX, NACK/DTX | n_{PUCCH, 1}⁽¹⁾ | 0, 1 |
| NACK/DTX, NACK/DTX, ACK, ACK | n_{PUCCH, 3}⁽¹⁾ | 0, 1 |
| NACK/DTX, NACK/DTX, ACK, NACK/DTX | n_{PUCCH, 2}⁽¹⁾ | 0, 0 |
| NACK/DTX, NACK/DTX, NACK/DTX, ACK | n_{PUCCH, 3}⁽¹⁾ | 0, 0 |
| NACK, NACK/DTX, NACK/DTX, NACK/DTX | n_{PUCCH, 0}⁽¹⁾ | 0, 0 |

| | |
|---|---|
| DTX, NACK/DTX, NACK/DTX, NACK/DTX | No Transmission |

TABLE X-5
(M = 3)

| | | | | RM Code |
|---|---|---|---|---|
| Pcell | Scell | Resource | Constellation | Input Bits |
| HARQ-ACK(0), | HARQ-ACK(0), | n_{PUCCH}⁽¹⁾ | b(0), b(1) | o(0), o(1), |
| HARQ-ACK(1), | HARQ-ACK(1), | | | o(2), o(3) |
| HARQ-ACK(2) | HARQ-ACK(2) | | | |
| ACK, ACK, ACK | ACK, ACK, ACK | n_{PUCCH, 1}⁽¹⁾ | 1, 1 | 1, 1, 1, 1 |
| ACK, ACK, | ACK, ACK, ACK | n_{PUCCH, 1}⁽¹⁾ | 0, 0 | 1, 0, 1, 1 |
| NACK/DTX | | | | |
| ACK, NACK/DTX, | ACK, ACK, ACK | n_{PUCCH, 3}⁽¹⁾ | 1, 1 | 0, 1, 1, 1 |
| any | | | | |
| NACK/DTX, any, | ACK, ACK, ACK | n_{PUCCH, 3}⁽¹⁾ | 0, 1 | 0, 0, 1, 1 |
| any | | | | |
| ACK, ACK, ACK | ACK, ACK, | n_{PUCCH, 0}⁽¹⁾ | 1, 0 | 1, 1, 1, 0 |
| | NACK/DTX | | | |
| ACK, ACK, | ACK, ACK, | n_{PUCCH, 3}⁽¹⁾ | 1, 0 | 1, 0, 1, 0 |
| NACK/DTX | NACK/DTX | | | |
| ACK, NACK/DTX, | ACK, ACK, | n_{PUCCH, 0}⁽¹⁾ | 0, 1 | 0, 1, 1, 0 |
| any | NACK/DTX | | | |
| NACK/DTX, any, | ACK, ACK, | n_{PUCCH, 3}⁽¹⁾ | 0, 0 | 0, 0, 1, 0 |
| any | NACK/DTX | | | |
| ACK, ACK, ACK | ACK, NACK/DTX, | n_{PUCCH, 2}⁽¹⁾ | 1, 1 | 1, 1, 0, 1 |
| | any | | | |
| ACK, ACK, | ACK, NACK/DTX, | n_{PUCCH, 2}⁽¹⁾ | 0, 1 | 1, 0, 0, 1 |
| NACK/DTX | any | | | |
| ACK, NACK/DTX, | ACK, NACK/DTX, | n_{PUCCH, 2}⁽¹⁾ | 1, 0 | 0, 1, 0, 1 |
| any | any | | | |
| NACK/DTX, any, | ACK, NACK/DTX, | n_{PUCCH, 2}⁽¹⁾ | 0, 0 | 0, 0, 0, 1 |
| any | any | | | |
| ACK, ACK, ACK | NACK/DTX, any, | n_{PUCCH, 1}⁽¹⁾ | 1, 0 | 1, 1, 0, 0 |
| | any | | | |
| ACK, ACK, | NACK/DTX, any, | n_{PUCCH, 1}⁽¹⁾ | 0, 1 | 1, 0, 0, 0 |
| NACK/DTX | any | | | |
| ACK, NACK/DTX, | NACK/DTX, any, | n_{PUCCH, 0}⁽¹⁾ | 1, 1 | 0, 1, 0, 0 |
| any | any | | | |
| NACK, any, any | NACK/DTX, any, | n_{PUCCH, 0}⁽¹⁾ | 0, 0 | 0, 0, 0, 0 |
| | any | | | |

| | | | |
|---|---|---|---|
| DTX, any, any | NACK/DTX, any, | No Transmission | 0, 0, 0, 0 |
| | any | | |

TABLE X-6
(M = 4)

| | | | | RM Code |
|---|---|---|---|---|
| Pcell | Scell | Resource | Constellation | Input Bits |
| HARQ-ACK(0), | HARQ-ACK(0), | n_{PUCCH}⁽¹⁾ | b(0), b(1) | o(0), o(1), |
| HARQ-ACK(1), | HARQ-ACK(1), | | | o(2), o(3) |
| HARQ-ACK(2), | HARQ-ACK(2), | | | |
| HARQ-ACK(3) | HARQ-ACK(3) | | | |
| ACK, ACK, ACK, | ACK, ACK, ACK, | n_{PUCCH, 1}⁽¹⁾ | 1, 1 | 1, 1, 1, 1 |
| NACK/DTX | NACK/DTX | | | |
| ACK, ACK, | ACK, ACK, ACK, | n_{PUCCH, 1}⁽¹⁾ | 0, 0 | 1, 0, 1, 1 |
| NACK/DTX, any | NACK/DTX | | | |
| ACK, DTX, | ACK, ACK, ACK, | n_{PUCCH, 3}⁽¹⁾ | 1, 1 | 0, 1, 1, 1 |
| DTX, DTX | NACK/DTX | | | |
| ACK, ACK, | ACK, ACK, ACK, | n_{PUCCH, 3}⁽¹⁾ | 1, 1 | 0, 1, 1, 1 |
| ACK, ACK | NACK/DTX | | | |
| NACK/DTX, any, | ACK, ACK, ACK, | n_{PUCCH, 3}⁽¹⁾ | 0, 1 | 0, 0, 1, 1 |
| any, any | NACK/DTX | | | |
| (ACK, | ACK, ACK, ACK, | n_{PUCCH, 3}⁽¹⁾ | 0, 1 | 0, 0, 1, 1 |
| NACK/DTX, any, | NACK/DTX | | | |
| any), except for | | | | |
| (ACK, DTX, | | | | |
| DTX, DTX) | | | | |
| ACK, ACK, ACK, | ACK, ACK, | n_{PUCCH, 0}⁽¹⁾ | 1, 0 | 1, 1, 1, 0 |
| NACK/DTX | NACK/DTX, any | | | |
| ACK, ACK, | ACK, ACK, | n_{PUCCH, 3}⁽¹⁾ | 1, 0 | 1, 0, 1, 0 |
| NACK/DTX, any | NACK/DTX, any | | | |
| ACK, DTX, | ACK, ACK, | n_{PUCCH, 0}⁽¹⁾ | 0, 1 | 0, 1, 1, 0 |
| DTX, DTX | NACK/DTX, any | | | |
| ACK, ACK, | ACK, ACK, | n_{PUCCH, 0}⁽¹⁾ | 0, 1 | 0, 1, 1, 0 |
| ACK, ACK | NACK/DTX, any | | | |
| NACK/DTX, any, | ACK, ACK, | n_{PUCCH, 3}⁽¹⁾ | 0, 0 | 0, 0, 1, 0 |
| any, any | NACK/DTX, any | | | |
| (ACK, | ACK, ACK, | n_{PUCCH, 3}⁽¹⁾ | 0, 0 | 0, 0, 1, 0 |
| NACK/DTX, any, | NACK/DTX, any | | | |
| any), except for | | | | |
| (ACK, DTX, | | | | |
| DTX, DTX) | | | | |
| ACK, ACK, ACK, | ACK, DTX, DTX, DTX | n_{PUCCH, 2}⁽¹⁾ | 1, 1 | 1, 1, 0, 1 |
| NACK/DTX | | | | |
| ACK, ACK, ACK, | ACK, ACK, ACK, ACK | n_{PUCCH, 2}⁽¹⁾ | 1, 1 | 1, 1, 0, 1 |
| NACK/DTX | | | | |
| ACK, ACK, | ACK, DTX, DTX, DTX | n_{PUCCH, 2}⁽¹⁾ | 0, 1 | 1, 0, 0, 1 |
| NACK/DTX, any | | | | |
| ACK, ACK, | ACK, ACK, ACK, ACK | n_{PUCCH, 2}⁽¹⁾ | 0, 1 | 1, 0, 0, 1 |
| NACK/DTX, any | | | | |
| ACK, DTX, | ACK, DTX, DTX, DTX | n_{PUCCH, 2}⁽¹⁾ | 1, 0 | 0, 1, 0, 1 |
| DTX, DTX | | | | |
| ACK, DTX, | ACK, ACK, ACK, ACK | n_{PUCCH, 2}⁽¹⁾ | 1, 0 | 0, 1, 0, 1 |
| DTX, DTX | | | | |
| ACK, ACK, | ACK, DTX, DTX, DTX | n_{PUCCH, 2}⁽¹⁾ | 1, 0 | 0, 1, 0, 1 |
| ACK, ACK | | | | |
| ACK, ACK, | ACK, ACK, ACK, ACK | n_{PUCCH, 2}⁽¹⁾ | 1, 0 | 0, 1, 0, 1 |
| ACK, ACK | | | | |
| NACK/DTX, any, | ACK, DTX, DTX, DTX | n_{PUCCH, 2}⁽¹⁾ | 0, 0 | 0, 0, 0, 1 |
| any, any | | | | |
| NACK/DTX, any, | ACK, ACK, ACK, ACK | n_{PUCCH, 2}⁽¹⁾ | 0, 0 | 0, 0, 0, 1 |
| any, any | | | | |
| (ACK, | ACK, DTX, DTX, DTX | n_{PUCCH, 2}⁽¹⁾ | 0, 0 | 0, 0, 0, 1 |
| NACK/DTX, any, | | | | |
| any), except for | | | | |
| (ACK, DTX, | | | | |
| DTX, DTX) | | | | |
| (ACK, | ACK, ACK, ACK, ACK | n_{PUCCH, 2}⁽¹⁾ | 0, 0 | 0, 0, 0, 1 |
| NACK/DTX, any, | | | | |
| any), except for | | | | |
| (ACK, DTX, | | | | |
| DTX, DTX) | | | | |
| ACK, ACK, ACK, | NACK/DTX, any, any, | n_{PUCCH, 1}⁽¹⁾ | 1, 0 | 1, 1, 0, 0 |
| NACK/DTX | any | | | |
| ACK, ACK, ACK, | (ACK, NACK/DTX, any, | n_{PUCCH, 1}⁽¹⁾ | 1, 0 | 1, 1, 0, 0 |
| NACK/DTX | any), except for (ACK, | | | |
| | DTX, DTX, DTX) | | | |
| ACK, ACK, | NACK/DTX, any, any, | n_{PUCCH, 1}⁽¹⁾ | 0, 1 | 1, 0, 0, 0 |
| NACK/DTX, any | any | | | |
| ACK, ACK, | (ACK, NACK/DTX, any, | n_{PUCCH, 1}⁽¹⁾ | 0, 1 | 1, 0, 0, 0 |
| NACK/DTX, any | any), except for (ACK, | | | |
| | DTX, DTX, DTX) | | | |
| ACK, DTX, | NACK/DTX, any, any, | n_{PUCCH, 0}⁽¹⁾ | 1, 1 | 0, 1, 0, 0 |
| DTX, DTX | any | | | |
| ACK, DTX, | (ACK, NACK/DTX, any, | n_{PUCCH, 0}⁽¹⁾ | 1, 1 | 0, 1, 0, 0 |
| DTX, DTX | any), except for (ACK, | | | |
| | DTX, DTX, DTX) | | | |
| ACK, ACK, | NACK/DTX, any, any, | n_{PUCCH, 0}⁽¹⁾ | 1, 1 | 0, 1, 0, 0 |
| ACK, ACK | any | | | |
| ACK, ACK, | (ACK, NACK/DTX, any, | n_{PUCCH, 0}⁽¹⁾ | 1, 1 | 0, 1, 0, 0 |
| ACK, ACK | any), except for (ACK, | | | |
| | DTX, DTX, DTX) | | | |
| NACK, any, any, | NACK/DTX, any, any, | n_{PUCCH, 0}⁽¹⁾ | 0, 0 | 0, 0, 0, 0 |
| any | any | | | |
| NACK, any, any, | (ACK, NACK/DTX, any, | n_{PUCCH, 0}⁽¹⁾ | 0, 0 | 0, 0, 0, 0 |
| any | any), except for (ACK, | | | |
| | DTX, DTX, DTX) | | | |
| (ACK, | NACK/DTX, any, any, | n_{PUCCH, 0}⁽¹⁾ | 0, 0 | 0, 0, 0, 0 |
| NACK/DTX, any, | any | | | |
| any), except for | | | | |
| (ACK, DTX, | | | | |
| DTX, DTX) | | | | |
| (ACK, | (ACK, NACK/DTX, any, | n_{PUCCH, 0}⁽¹⁾ | 0, 0 | 0, 0, 0, 0 |
| NACK/DTX, any, | any), except for (ACK, | | | |
| any), except for | DTX, DTX, DTX) | | | |
| (ACK, DTX, | | | | |
| DTX, DTX) | | | | |

| | | | |
|---|---|---|---|
| DTX, any, any, | NACK/DTX, any, any, | No Transmission | 0, 0, 0, 0 |
| any | any | | |
| DTX, any, any, | (ACK, NACK/DTX, any, | No Transmission | 0, 0, 0, 0 |
| any | any), except for (ACK, | | |
| | DTX, DTX, DTX) | | |

The fourth exemplary embodiment of the present invention is described below.

### Exemplary Embodiment Twenty One

As for the situation that the DL sub-frames of the Scell belong to the sub-set of the DL sub-frames of the Pcell, the timing relationship of the HARQ-ACK corresponding to the PDSCH on the Scell is determined according to the timing relationship of the TDD UL/DL configuration of the Pcell. For example, the Pcell adopts the TDD UL/DL configuration 2 and the Scell adopts the TDD UL/DL configuration 1.

As for the Pcell, the bundling windows corresponding to UL sub-frame 7, which transmits the HARQ-ACK information on the Pcell, include sub-frames 9, 0, 1 and 3 according to the timing of the UL/DL configuration of the Pcell. For example, the number of the bundling windows is four. As for the Scell, the bundling windows corresponding to the UL sub-frame 7 also include sub-frames 9, 0, 1 and 3 according to the UL/DL configuration of the Pcell, wherein the sub-frame 3 is the UL sub-frame. However, from the perspective of simplified processing, the definition of the bundling window of the UL/DL configuration of the Pcell is reused. For example, the number of the bundling windows is four. Alternatively, as for the Scell, in defining the bundling window with the UL/DL configuration of the Pcell, only the sub-frame which exists is defined as the bundling window of the Scell. For example, the bundling windows of the Scell include sub-frames 9, 0 and 1. The number of the bundling windows is three. The above two exemplary methods for defining the bundling window need not to be distinguished according to the fourth exemplary embodiment of the present invention. Since the larger value M of the bundling windows of the two CCs needs to be equal to the number of the bundling windows defined in the TDD UL/DL configuration of the Pcell. In this exemplary embodiment of the present invention, M equals to four. Therefore, the two CCs may be processed according to number M of the bundling windows of the UL/DL configuration of the Pcell. For instance, the two CCs are processed according to the mapping relationship of Table X-6. As for the Scell, the feedback information of the DL sub-frame which does not exist is defined as the DTX, or (DTX, DTX).

### Exemplary Embodiment Twenty Two

According to the current definition of the non cross-carrier scheduling, as for the situation that the DL sub-frames of the Scell belong to the superset of the DL sub-frames of the Pcell, the timing relationship of the HARQ-ACK corresponding to the PDSCH on the Scell is determined according to the timing relationship of the TDD UL/DL configuration of the Scell. For example, the Pcell adopts the TDD UL/DL configuration 1 and the Scell adopts the TDD UL/DL configuration 2.

As for the Pcell, the bundling windows corresponding to the UL sub-frame 7 which transmits the HARQ-ACK information on the Pcell include sub-frames 0 and 1 according to the timing of the TDD UL/DL configuration of the Pcell. For example, the number of the bundling windows is two. As for the Scell, the bundling windows corresponding to the UL sub-frame 7 include sub-frames 9, 0, 1 and 3 according to the timing of the TDD UL/DL configuration of the Scell. For example, the number of the bundling windows is four. According to the fourth exemplary embodiment of the present invention, since the larger value M of the bundling windows of the two CCs equals to four, the two CCs may be processed according to number M, which equals to four, of the bundling windows of the TDD UL/DL configuration of the Scell. For instance, the two CCs are processed according to the mapping relationship of Table X-6. Here, as for the Pcell, the feedback information of the DL sub-frame which does not exist is defined as the DTX, or (DTX, DTX).

In an exemplary timing method, for the situation that the DL sub-frames of the Scell belong to the superset of the DL sub-frames of the Pcell, the timing relationship of the HARQ-ACK corresponding to the PDSCH on the Scell is stilled determined according to the timing relationship of the TDD UL/DL configuration of the Pcell. For example, the Pcell adopts the TDD UL/DL configuration 1 and the Scell adopts the TDD UL/DL configuration 2.

As for the Pcell, the bundling windows corresponding to the UL sub-frame 7, which transmits the HARQ-ACK information on the Pcell, include sub-frames 0 and 1 according to the timing of the TDD UL/DL configuration of the Pcell. For example, the number of the bundling windows is two. As for the Scell, the bundling windows corresponding to the UL sub-frame 7 also include sub-frames 0 and 1 according to the timing of the TDD UL/DL configuration of the Pcell. For example, the number of the bundling windows is two. For example, the number of the bundling windows of the two CCs is the same. Therefore, the two CCs may be processed according to number M, which equals to two of the bundling windows of the TDD UL/DL configuration of the Pcell. For instance, the two CCs are processed according to the mapping relationship of Table X-4.

### Exemplary Embodiment Twenty Three

According to the current definition of the non cross-carrier scheduling, as for the situation that the DL sub-frames of the Scell neither belong to the subset nor the superset of the DL sub-frames of the Pcell, the timing relationship of the HARQ-ACK corresponding to the PDSCH on the Scell is determined according to the timing relationship of a reference TDD UL/DL configuration. For instance, according to Table Y-1, the UL sub-frames in the reference TDD UL/DL configuration is the intersection of the UL sub-frames of the Pcell and those of the Scell. For example, the Pcell adopts the TDD UL/DL configuration 1 and the Scell adopts the TDD UL/DL configuration 3. Thereafter, TDD UL/DL configuration 4 is used for determining the timing relationship of the Scell.

As for the Pcell, the bundling windows corresponding to the UL sub-frame 2, which transmits the HARQ-ACK information on the Pcell, include sub-frames 5 and 6 according to the timing of the TDD UL/DL configuration of the Pcell. For example, the number of the bundling windows is two. As for the Scell, the bundling windows corresponding to the UL sub-frame 2 also include sub-frames 0, 1, 4 and 5 according to the timing of the TDD UL/DL configuration 4 for determining the timing relationship of the Scell, wherein the sub-frame 4 is the UL sub-frame. However, from the perspective of simplified processing, the definition of the bundling window of the TDD UL/DL configuration 4 for determining the timing relationship of the Scell is reused. For example, the number of the bundling windows is four. According to the fourth exemplary embodiment of the present invention, since the larger value of the bundling windows of the two CCs is M, which equals to four, the two CCs may be processed according to number M of the bundling windows. For instance, the two CCs are processed according to the mapping relationship of Table X-6. Here, as for Pcell the Scell, the feedback information of the DL sub-frame which does not exist is defined as the DTX, or (DTX, DTX).

Alternatively, also as for the Scell, in defining the bundling window with the TDD UL/DL configuration 4 for determining the timing relationship of the Scell, only the sub-frame which exists are defined as the bundling windows of the Scell. For example, the bundling window of the Scell includes sub-frames 0, 1 and 5. The number of the bundling windows is three. Thereafter, according to the fourth exemplary embodiment of the present invention, since the larger value of the bundling windows of the two CCs is M, which equals to three, the two CCs may be processed according to number M of the bundling windows. For instance, the two CCs are processed according to the mapping relationship of Table X-5. Here, as for the Pcell, the feedback information of the DL sub-frame which does not exist is defined as the DTX, or (DTX, DTX).

In an exemplary timing method, the timing relationship of the HARQ-ACK corresponding to the PDSCH on the Scell is also determined according to the timing relationship of the TDD UL/DL configuration of the Pcell. For example, the Pcell adopts the TDD UL/DL configuration 1 and the Scell adopts the TDD UL/DL configuration 3.

As for the Pcell, the bundling window corresponding to the UL sub-frame 8, which transmits the HARQ-ACK information on the Pcell, includes sub-frame 4 according to the timing of the TDD UL/DL configuration of the Pcell. For example, the number of the bundling window is one. As for the Scell, the bundling window corresponding to the UL sub-frame 8 also includes sub-frame 4 according to the timing of the TDD UL/DL configuration of the Pcell, wherein sub-frame 4 is a UL sub-frame. From the perspective of simplified processing, the definition of the bundling window of the UL/DL configuration of the Pcell is reused. For example, the number of the bundling window is one.

Alternatively, also as for the Scell, in defining the bundling window with the TDD UL/DL configuration of the Pcell, only the sub-frame which exists is defined as the bundling window of the Scell. For example, the number of the bundling window of the Scell is zero. However, according to the fourth exemplary embodiment of the present invention, the definitions of the above two bundling windows need not to be distinguished. The larger value M of the bundling window of the two CCs needs to be equal to the number of the bundling window defined in the TDD UL/DL configuration of the Pcell. In this exemplary embodiment of the present invention, M equals to one. Therefore, the two CCs may be processed according to number M of the bundling window of the UL/DL configuration of the Pcell. For instance, the two CCs are processed according to the mapping relationships of Table X-1, Table X-2 and Table X-3. As for the Scell, the feedback information of the DL sub-frame which does not exist is defined as the DTX, or (DTX, DTX).

The exemplary method for defining the feedback information of the sub-frame which does not exist as the DTX, or (DTX, DTX) as described in the fourth exemplary embodiment of the present invention includes the following.

When the number M of the bundling windows of a specific CC is less than the maximum value M_max of the bundling windows of the two CCs, and the M_max of the bundling windows of the two CCs equals to two, the following two exemplary methods may be implemented.

In exemplary method one, the DTX is filled in front of the HARQ-ACK information, which is generated according to the number M of the bundling windows of the specific CC, to make the length of the HARQ-ACK information of the specific CC after the filling equal to the length of the HARQ-ACK information of the bundling windows with the M_max of the two CCs.

In exemplary method two, the DTX is filled behind the HARQ-ACK information, which is generated according to the number M of the bundling windows of the specific CC, to make the length of the HARQ-ACK information of the specific CC after the filling equal to the length of the HARQ-ACK information of the bundling windows with the M_max of the two CCs.

### Exemplary Embodiment Twenty Four

FIG. 5 is schematic diagram illustrating a number of bundling windows of two CCs according to a twenty fourth exemplary embodiment of the present invention.

Referring to FIG. 5, when the Pcell adopts the TDD UL/DL configuration 6 and the Scell adopts the TDD UL/DL configuration 3, the bundling window corresponding to the UL sub-frame 3, which transmits the HARQ-ACK information on the Pcell, includes sub-frame 6. For example, the number of the bundling window is one. As for the Scell, the bundling windows corresponding to the UL sub-frame 3 include sub-frames 7 and 8 according to the TDD UL/DL configuration of the Pcell. The number of the bundling windows is two. As shown in FIG. 5, the maximum value of the bundling windows of the two CCs is two, both the Pcell and the Scell are processed according to the situation that the number of the bundling windows is two. According to the exemplary method one described above, one DTX may be filled in front of the HARQ-ACK information of the Pcell. According to the exemplary method two described above, one DTX may be filled behind the HARQ-ACK information of the Pcell.

When the number M of the bundling windows of a specific CC is less than the maximum value M_max of the bundling windows of the two CCs, and the M_max of the bundling windows of the two CCs is larger than two, the following two exemplary methods may be implemented.

In exemplary method one, M_max-M DTX is filled in front of the HARQ-ACK information, which is generated according to the number M of the bundling windows of the specific CC, to make the length of the HARQ-ACK information of the specific CC after the filling equal to the length of the HARQ-ACK information of the bundling windows with the maximum value of the two CCs.

In exemplary method two, M_max-M DTX is filled behind the HARQ-ACK information, which is generated according to the number M of the bundling windows of the specific CC, to make the length of the HARQ-ACK information of the specific CC after the filling equal to the length of the HARQ-ACK information of the bundling windows with maximum value of the two CCs.

### Exemplary Embodiment Twenty Five

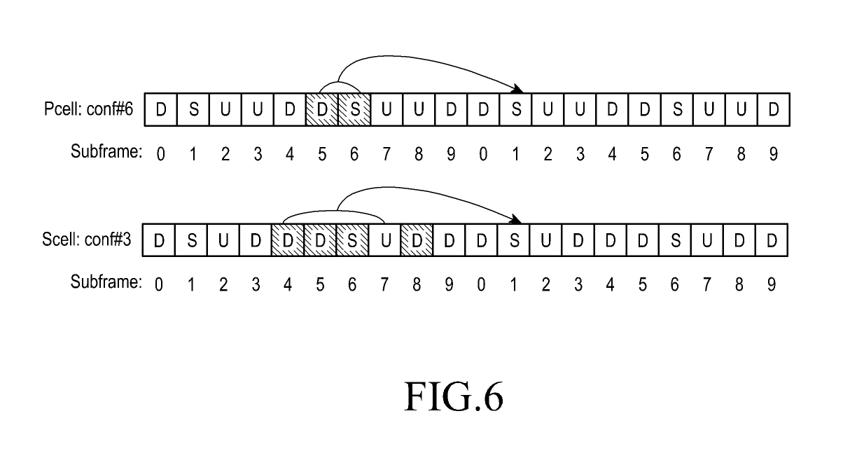

FIG. 6 is a schematic diagram illustrating a number of bundling windows of two CCs according to a twenty fifth exemplary embodiment of the present invention.

Referring to FIG. 6, when the Pcell adopts the TDD UL/DL configuration 1 and the Scell adopts the TDD UL/DL configuration 2, the bundling windows corresponding to the UL sub-frame 2, which transmits the HARQ-ACK information on the Pcell, include sub-frames 5 and 6. For example, the number of the bundling windows is two. As for the Scell, the bundling windows corresponding to the UL sub-frame 2 include sub-frames 8, 7, 6 and 4 according to the TDD UL/DL configuration of the Scell. The number of the bundling windows is four. As shown in FIG. 6, the maximum value of the bundling windows of the two CCs is four, and both the Pcell and the Scell are processed according to the situation that the number of the bundling windows is four. According to the exemplary method one described above, two DTX may be filled in front of the HARQ-ACK information of the Pcell. According to the exemplary method two described above, two DTX may be filled behind the HARQ-ACK information of the Pcell.

It can be seen from the above exemplary embodiments of the present invention that with the method for transmitting the HARQ-ACK feedback information, after performing the group bundling on the collection of the HARQ-ACK feedback information of all the sub-frames of the two CCs in a HARQ-ACK feedback period, and the HARQ-ACK feedback information after the group bundling may be transmitted to the base station adopting the PUCCH format 1b of the channel selection according to the PUCCH channel resources mapped from the HARQ-ACK feedback information after the group bundling and modulation symbols. Exemplary embodiments of the present invention implement the correct HARQ-ACK feedback information transmission, attempt to reduce the influence of the group bundling on the data transmission, optimize the throughput performance of the data transmission, and further effectively support the situation the UL/DL configurations of multiple CCs of the CA are different, when the TDD UL/DL configurations of the two CCs of the CA are different, and under the situation that the HARQ-ACK feedback information of the two CCs is unbalanced.

The foregoing only describes exemplary embodiments of the present invention, which are not limited to the above description. Any change or substitution, easily occurring to those skilled in the art, should be covered by the protection scope of the present invention.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for transmitting Hybrid Automatic Repeat reQuest-ACKnowledgement (HARQ-ACK) feedback information, the method comprising:
receiving, by a User Equipment (UE), Physical Downlink Shared Channel (PDSCH) data from two Component Carriers (CCs) with different Time-division Multiplexing (TDD) uplink and downlink configurations, and obtaining corresponding HARQ-ACK feedback information;
performing, by the UE, group bundling on the HARQ-ACK feedback information of all sub-frames in a current HARQ-ACK bundling window of the two CCs, and obtaining HARQ-ACK feedback information, a total number of bits of which is less than or equal to four;
determining, by the UE, a number of Physical Uplink Control Channel (PUCCH) resources provided for transmission of the HARQ-ACK feedback information according to data transmission modes of the two CCs, and a number of elements in the bundling window of the two CCs; and
transmitting, by the UE, the HARQ-ACK feedback information after the group bundling to a base station on PUCCH channel resources adopting a PUCCH format 1b of channel selection according to the PUCCH resources mapped from the HARQ-ACK feedback information after the group bundling and modulation symbols.

2. The method of claim 1, wherein the group bundling comprises:
generating at most two bits of the HARQ-ACK feedback information according to respective bundling window of the two CCs.

3. The method of claim 2, wherein the generating of the at most two bits of the HARQ-ACK feedback information comprises:
if bundling window size of a CC is one, HARQ-ACK feedback information of the CC is one bit when the CC is configured with Single Input Multiple Output (SIMO) transmission, and the HARQ-ACK feedback information of the CC is two bits when the CC is configured with Multiple Input Multiple Output (MIMO) transmission;
if bundling window size of the CC is two, the HARQ-ACK feedback information of the CC is two bits when the CC is configured with the SIMO transmission, and the HARQ-ACK feedback information is four bits when the CC is configured with the MIMO transmission, performing spatial bundling on the four bits of the HARQ-ACK feedback information to generate two bits of the HARQ-ACK feedback information; and
if the bundling window size of the CC is larger than two, performing time domain bundling on the HARQ-ACK feedback information of the CC to generate two bits of the HARQ-ACK feedback information when the CC is configured with the SIMO transmission, and performing the spatial bundling on the HARQ-ACK feedback information of the CC first, and then performing time domain bundling on the HARQ-ACK feedback information after the spatial bundling to generate two bits of the HARQ-ACK feedback information when the CC is configured with the MIMO transmission.

4. The method of claim 3 further comprising:
providing at most two PUCCH format 1a/1b resources for each CC.

5. The method of claim 4, wherein the providing of the at most two PUCCH format 1a/1b resources for each CC comprises:
if the bundling window size of the CC is one, providing one PUCCH format 1a/1b resource which is obtained by an index of a first Control Channel Element (CCE) occupied by a Physical Downlink Control Channel (PDCCH) scheduling the PDSCH or indicated by an HARQ-ACK Resource Indicator (ARI) in the PDCCH scheduling the PDSCH for the CC when the CC is configured with the SIMO transmission, and providing two PUCCH format 1a/1b resources which are obtained by the index of the first CCE and an index of a second index occupied by PDCCHs scheduling PDSCHs or indicated by ARIs in the PDCCHs scheduling the PDSCHs for the CC when the CC is configured with the MIMO transmission;
if the bundling window size of the CC is two, providing two PUCCH format 1a/1b resources which are obtained by the indexes of the first CCEs occupied by the PDCCHs of sub-frame 0 and sub-frame 1 or indicated by the ARIs in the PDCCHs scheduling the PDSCHs for the CC; and
if the bundling window size of the CC is larger than two, providing two PUCCH format 1a/1b resources which are obtained by the indexes of the first CCEs occupied by the PDCCHs, Downlink Assignment Indexes (DAIs) of which are one and two or indicated by the ARIs in the PDCCHs scheduling the PDSCHs for the CC, wherein when a Semi-Persistent Scheduling (SPS) service exists, a PUCCH format 1a/1b resource by semi-static allocation of the SPS service is a first PUCCH format 1a/1b resource, while a PUCCH format 1a/1b resource got by the index of the first CCE occupied by the PDCCH, the DAI of which is one, is a second PUCCH format 1a/1b resource.

6. The method of claim 1, wherein the group bundling comprises:
performing spatial bundling on the HARQ-ACK feedback information of all the sub-frames in the current HARQ-ACK feedback period of the two CCs;
if the total number of the bits of the HARQ-ACK feedback information after the spatial bundling equals to four, dividing the HARQ-ACK feedback information after the spatial bundling into two groups to make the total number of bits of the HARQ-ACK feedback information of each group equal to two; and
if the total number of the bits of the HARQ-ACK feedback information after the spatial bundling is larger than four, dividing the HARQ-ACK feedback information after the spatial bundling into two groups to make each group comprise at least two bits, performing time domain bundling on the HARQ-ACK feedback information, the total number of bits of which is larger than two after the grouping to make the total number of the bits of the HARQ-ACK feedback information of each group equal to two.

7. The method of claim 6, wherein:
after the spatial bundling and time domain bundling, a number of bits of HARQ-ACK feedback information provided by each CC determines a number of PUCCH format 1a/1b resources provided for each CC;
if the number of the bit of the HARQ-ACK feedback information provided by the CC is one, providing one PUCCH format 1a/1b resource which is obtained by an index of a first CCE occupied by a PDCCH scheduling a PDSCH or indicated by an ARI in the PDCCH scheduling the PDSCH for the CC;
if the number of the bits of the HARQ-ACK feedback information provided by the CC is two, providing two PUCCH format 1a/1b resources which are obtained by indexes of the first CCEs occupied by PDCCHs, DAIs of which are one and two or indicated by ARIs in PDCCHs scheduling PDSCHs for the CC; and
if the number of the bits of the HARQ-ACK feedback information provided by the CC is three, providing three PUCCH format 1a/1b resources which are obtained by the indexes of the first CCEs occupied by the PDCCHs, DAIs of which are one, two and three or indicated by the ARIs in the PDCCHs scheduling PDSCHs.

8. The method of claim 6, further comprising at least one of:
taking, according to an order of a number of the sub-frames, HARQ-ACK feedback information of N, which is larger than or equal to one, sub-frames with the maximum number in the current HARQ-ACK feedback period of another CC and the HARQ-ACK feedback information of all the sub-frames of the CC as one group, and taking HARQ-ACK feedback information of the other sub-frames except for the N sub-frames in the current HARQ-ACK feedback period of the another CC as a group; and
taking, according to the order of DAIs of the sub-frames, the HARQ-ACK feedback information of M, which is larger than or equal to one, sub-frames with the maximum DAI value in the current HARQ-ACK feedback period of the another CC and the HARQ-ACK feedback information of all the sub-frames of the CC as one group, and taking the HARQ-ACK feedback information of the other sub-frames except for the M sub-frames in the current HARQ-ACK feedback period of the another CC as a group.

9. The method of claim 6, further comprising at least one of:
taking, according to an order of a number of the sub-frames, HARQ-ACK feedback information of N, which is larger than or equal to one, sub-frames with the minimum number in a current HARQ-ACK feedback period of another CC and the HARQ-ACK feedback information of all the sub-frames of the CC as a group, and taking HARQ-ACK feedback information of the other sub-frames except for the N sub-frames in the current HARQ-ACK feedback period of the another CC as a group; and
taking, according to the order of DAIs of the sub-frames, the HARQ-ACK feedback information of M, which is larger than or equal to one, sub-frames with the maximum DAI value in the current HARQ-ACK feedback period of another CC and the HARQ-ACK feedback information of all the sub-frames of the CC as one group, and taking the HARQ-ACK feedback information of the other sub-frames except for the M sub-frames in the current HARQ-ACK feedback period of the another CC as a group.

10. The method of claim 1, wherein the group bundling comprises:
performing spatial bundling on the HARQ-ACK feedback information of all the sub-frames in the current HARQ-ACK feedback period of the two CCs, wherein
if the number of the bundling window of the CC is one, the HARQ-ACK feedback information is one bit,
if the number of the bundling windows of the CC is two, two bits of the HARQ-ACK feedback information are generated, and
if the number of the bundling windows of the CC is larger than two, time domain bundling is performed on the HARQ-ACK feedback information after spatial bundling to generate two bits of the HARQ-ACK feedback information.

11. The method of claim 10, further comprising:
providing at most two PUCCH format 1a/1b resources for each CC.

12. The method of claim 11, wherein the providing of the at most two PUCCH format 1a/1b resources for each CC comprises:
if the number of the bundling window of the CC is one, providing one PUCCH format 1a/1b resource which is obtained by an index of a first CCE occupied by a PDCCH scheduling the PDSCH or indicated by an ARI in the PDCCH scheduling the PDSCH for the CC;
if the number of the bundling windows of the CC is two, providing two PUCCH format 1a/1b resources which are obtained by the indexes of the first CCEs occupied by the PDCCHs of sub-frame 0 and sub-frame 1 or indicated by ARIs in PDCCHs scheduling PDSCHs for the CC; and
if the number of the bundling windows of the CC is larger than two, providing two PUCCH format 1a/1b resources which are obtained by the indexes of the first CCEs occupied by the PDCCHs, DAIs of which are one and two or indicated by the ARIs in the PDCCHs scheduling the PDSCHs for the CC, wherein when a SPS service exists, a PUCCH format 1a/1b resource of semi-static allocation of the SPS service is a first PUCCH format 1a/1b resource, while a PUCCH format 1a/1b resource got by the index of the first CCE occupied by the PDCCH, the DAI of which is one, is the second PUCCH format 1a/1b resource.

13. The method of claim 3, further comprising:
performing the time domain bundling on the HARQ-ACK feedback information, the total number of bits of which is larger than two according to an order of a number of the sub-frames, or performing the time domain bundling on the HARQ-ACK feedback information, the total number of the bits of which is larger than two according to an order of DAIs of the sub-frames.

14. The method of claim 1, further comprising:
denoting a larger value of bundling windows of the two CCs as M, feeding back HARQ-ACK information of the two CCs according to PUCCH format 1b feedback mapping tables as shown in Table X-1, Table X-2, Table X-3, Table X-4, Table X-5 and Table X-6, wherein
the Table X-1 is used for a situation that M equals to one, and sum of bits of HARQ-ACK of the two CCs is two,
the Table X-2 is used for a situation that M equals to one, and the sum of the bits of the HARQ-ACK of the two CCs is three,
the Table X-3 is used for a situation that M equals to one, and the sum of the bits of the HARQ-ACK of the two CCs is four,
the Table X-4 is used for a situation that M equals to two,
the Table X-5 is used for a situation that M equals to three,
the Table X-6 is used for a situation that M equals to four,
in each table, HARQ-ACK(i), i=0˜3 denotes the HARQ-ACK feedback information before mapping, and is the HARQ-ACK feedback information after the mapping, and wherein
TABLE X-1
(M = 1, A = 2)

| HARQ-ACK(0), HARQ-ACK(1) | n_{PUCCH}⁽¹⁾ | b(0)b(1) |
|---|---|---|
| ACK, ACK | n_{PUCCH, 1}⁽¹⁾ | 1, 0 |
| ACK, NACK/DTX | n_{PUCCH, 0}⁽¹⁾ | 1, 1 |
| NACK/DTX, ACK | n_{PUCCH, 1}⁽¹⁾ | 0, 1 |
| NACK, NACK/DTX | n_{PUCCH, 0}⁽¹⁾ | 0, 0 |
| | |
|---|---|
| DTX, NACK/DTX | No Transmission |

TABLE X-2
(M = 1, A = 3)

| HARQ-ACK(0), HARQ-ACK(1), | | |
|---|---|---|
| HARQ-ACK(2) | n_{PUCCH}⁽¹⁾ | b(0)b(1) |
| ACK, ACK, ACK | n_{PUCCH, 2}⁽¹⁾ | 1, 1 |
| ACK, ACK, NACK/DTX | n_{PUCCH, 1}⁽¹⁾ | 1, 0 |
| ACK, NACK/DTX, ACK | n_{PUCCH, 2}⁽¹⁾ | 1, 0 |
| ACK, NACK/DTX, NACK/DTX | n_{PUCCH, 0}⁽¹⁾ | 1, 1 |
| NACK/DTX, ACK, ACK | n_{PUCCH, 2}⁽¹⁾ | 0, 1 |
| NACK/DTX, ACK, NACK/DTX | n_{PUCCH, 1}⁽¹⁾ | 0, 1 |
| NACK/DTX, NACK/DTX, ACK | n_{PUCCH, 2}⁽¹⁾ | 0, 0 |
| NACK, NACK/DTX, NACK/DTX | n_{PUCCH, 0}⁽¹⁾ | 0, 0 |
| | |
|---|---|
| DTX, NACK/DTX, NACK/DTX | No Transmission |

TABLE X-3
(M = 1, A = 4)

| HARQ-ACK(0), HARQ-ACK(1), | | |
|---|---|---|
| HARQ-ACK(2), HARQ-ACK(3) | n_{PUCCH}⁽¹⁾ | b(0)b(1) |
| ACK, ACK, ACK, ACK | n_{PUCCH, 1}⁽¹⁾ | 1, 1 |
| ACK, ACK, ACK, NACK/DTX | n_{PUCCH, 2}⁽¹⁾ | 1, 1 |
| ACK, ACK, NACK/DTX, ACK | n_{PUCCH, 0}⁽¹⁾ | 1, 0 |
| ACK, ACK, NACK/DTX, NACK/DTX | n_{PUCCH, 1}⁽¹⁾ | 1, 0 |
| ACK, NACK/DTX, ACK, ACK | n_{PUCCH, 3}⁽¹⁾ | 1, 1 |
| ACK, NACK/DTX, ACK, NACK/DTX | n_{PUCCH, 2}⁽¹⁾ | 1, 0 |
| ACK, NACK/DTX, NACK/DTX, ACK | n_{PUCCH, 0}⁽¹⁾ | 0, 1 |
| ACK, NACK/DTX, NACK/DTX, NACK/DTX | n_{PUCCH, 0}⁽¹⁾ | 1, 1 |
| NACK/DTX, ACK, ACK, ACK | n_{PUCCH, 1}⁽¹⁾ | 0, 0 |
| NACK/DTX, ACK, ACK, NACK/DTX | n_{PUCCH, 2}⁽¹⁾ | 0, 1 |
| NACK/DTX, ACK, NACK/DTX, ACK | n_{PUCCH, 3}⁽¹⁾ | 1, 0 |
| NACK/DTX, ACK, NACK/DTX, NACK/DTX | n_{PUCCH, 1}⁽¹⁾ | 0, 1 |
| NACK/DTX, NACK/DTX, ACK, ACK | n_{PUCCH, 3}⁽¹⁾ | 0, 1 |
| NACK/DTX, NACK/DTX, ACK, NACK/DTX | n_{PUCCH, 2}⁽¹⁾ | 0, 0 |
| NACK/DTX, NACK/DTX, NACK/DTX, ACK | n_{PUCCH, 3}⁽¹⁾ | 0, 0 |
| NACK, NACK/DTX, NACK/DTX, NACK/DTX | n_{PUCCH, 0}⁽¹⁾ | 0, 0 |
| | |
|---|---|
| DTX, NACK/DTX, NACK/DTX, NACK/DTX | No Transmission |

TABLE X-4
(M = 2)

| HARQ-ACK(0), HARQ-ACK(1), | | |
|---|---|---|
| HARQ-ACK(2), HARQ-ACK(3) | n_{PUCCH}⁽¹⁾ | b(0)b(1) |
| ACK, ACK, ACK, ACK | n_{PUCCH, 1}⁽¹⁾ | 1, 1 |
| ACK, ACK, ACK, NACK/DTX | n_{PUCCH, 2}⁽¹⁾ | 1, 1 |
| ACK, ACK, NACK/DTX, ACK | n_{PUCCH, 0}⁽¹⁾ | 1, 0 |
| ACK, ACK, NACK/DTX, NACK/DTX | n_{PUCCH, 1}⁽¹⁾ | 1, 0 |
| ACK, NACK/DTX, ACK, ACK | n_{PUCCH, 3}⁽¹⁾ | 1, 1 |
| ACK, NACK/DTX, ACK, NACK/DTX | n_{PUCCH, 2}⁽¹⁾ | 1, 0 |
| ACK, NACK/DTX, NACK/DTX, ACK | n_{PUCCH, 0}⁽¹⁾ | 0, 1 |
| ACK, NACK/DTX, NACK/DTX, NACK/DTX | n_{PUCCH, 0}⁽¹⁾ | 1, 1 |
| NACK/DTX, ACK, ACK, ACK | n_{PUCCH, 1}⁽¹⁾ | 0, 0 |
| NACK/DTX, ACK, ACK, NACK/DTX | n_{PUCCH, 2}⁽¹⁾ | 0, 1 |
| NACK/DTX, ACK, NACK/DTX, ACK | n_{PUCCH, 3}⁽¹⁾ | 1, 0 |
| NACK/DTX, ACK, NACK/DTX, NACK/DTX | n_{PUCCH, 1}⁽¹⁾ | 0, 1 |
| NACK/DTX, NACK/DTX, ACK, ACK | n_{PUCCH, 3}⁽¹⁾ | 0, 1 |
| NACK/DTX, NACK/DTX, ACK, NACK/DTX | n_{PUCCH, 2}⁽¹⁾ | 0, 0 |
| NACK/DTX, NACK/DTX, NACK/DTX, ACK | n_{PUCCH, 3}⁽¹⁾ | 0, 0 |
| NACK, NACK/DTX, NACK/DTX, NACK/DTX | n_{PUCCH, 0}⁽¹⁾ | 0, 0 |
| | |
|---|---|
| DTX, NACK/DTX, NACK/DTX, NACK/DTX | No Transmission |

TABLE X-5
(M = 3)

| | | | | Input bits |
|---|---|---|---|---|
| PCC | SCC | Resource | Map | of RM codes |
| HARQ-ACK(0), | HARQ-ACK(0), | n_{PUCCH}⁽¹⁾ | b(0), b(1) | o(0), o(1), |
| HARQ-ACK(1), | HARQ-ACK(1), | | | o(2), o(3) |
| HARQ-ACK(2) | HARQ-ACK(2) | | | |
| ACK, ACK, ACK | ACK, ACK, ACK | n_{PUCCH, 1}⁽¹⁾ | 1, 1 | 1, 1, 1, 1 |
| ACK, ACK, | ACK, ACK, ACK | n_{PUCCH, 1}⁽¹⁾ | 0, 0 | 1, 0, 1, 1 |
| NACK/DTX | | | | |
| ACK, NACK/DTX, | ACK, ACK, ACK | n_{PUCCH, 3}⁽¹⁾ | 1, 1 | 0, 1, 1, 1 |
| any | | | | |
| NACK/DTX, any, | ACK, ACK, ACK | n_{PUCCH, 3}⁽¹⁾ | 0, 1 | 0, 0, 1, 1 |
| any | | | | |
| ACK, ACK, ACK | ACK, ACK, | n_{PUCCH, 0}⁽¹⁾ | 1, 0 | 1, 1, 1, 0 |
| | NACK/DTX | | | |
| ACK, ACK, | ACK, ACK, | n_{PUCCH, 3}⁽¹⁾ | 1, 0 | 1, 0, 1, 0 |
| NACK/DTX | NACK/DTX | | | |
| ACK, NACK/DTX, | ACK, ACK, | n_{PUCCH, 0}⁽¹⁾ | 0, 1 | 0, 1, 1, 0 |
| any | NACK/DTX | | | |
| NACK/DTX, any, | ACK, ACK, | n_{PUCCH, 3}⁽¹⁾ | 0, 0 | 0, 0, 1, 0 |
| any | NACK/DTX | | | |
| ACK, ACK, ACK | ACK, NACK/DTX, | n_{PUCCH, 2}⁽¹⁾ | 1, 1 | 1, 1, 0, 1 |
| | any | | | |
| ACK, ACK, | ACK, NACK/DTX, | n_{PUCCH, 2}⁽¹⁾ | 0, 1 | 1, 0, 0, 1 |
| NACK/DTX | any | | | |
| ACK, NACK/DTX, | ACK, NACK/DTX, | n_{PUCCH, 2}⁽¹⁾ | 1, 0 | 0, 1, 0, 1 |
| any | any | | | |
| NACK/DTX, any, | ACK, NACK/DTX, | n_{PUCCH, 2}⁽¹⁾ | 0, 0 | 0, 0, 0, 1 |
| any | any | | | |
| ACK, ACK, ACK | NACK/DTX, any, any | n_{PUCCH, 1}⁽¹⁾ | 1, 0 | 1, 1, 0, 0 |
| ACK, ACK, | NACK/DTX, any, any | n_{PUCCH, 1}⁽¹⁾ | 0, 1 | 1, 0, 0, 0 |
| NACK/DTX | | | | |
| ACK, NACK/DTX, | NACK/DTX, any, any | n_{PUCCH, 0}⁽¹⁾ | 1, 1 | 0, 1, 0, 0 |
| any | | | | |
| NACK, any, any | NACK/DTX, any, any | n_{PUCCH, 0}⁽¹⁾ | 0, 0 | 0, 0, 0, 0 |
| | | | |
|---|---|---|---|
| DTX, any, any | NACK/DTX, any, any | No Transmission | 0, 0, 0, 0 |

TABLE X-6
(M = 4)

| | | | | Input bits |
|---|---|---|---|---|
| PCC | SCC | Resource | Map | of RMcodes |
| HARQ-ACK(0), | HARQ-ACK(0), | n_{PUCCH}⁽¹⁾ | b(0), b(1) | o(0), o(1), |
| HARQ-ACK(1), | HARQ-ACK(1), | | | o(2), o(3) |
| HARQ-ACK(2), | HARQ-ACK(2), | | | |
| HARQ-ACK(3) | HARQ-ACK(3) | | | |
| ACK, ACK, ACK, | ACK, ACK, ACK, | n_{PUCCH, 1}⁽¹⁾ | 1, 1 | 1, 1, 1, 1 |
| NACK/DTX | NACK/DTX | | | |
| ACK, ACK, | ACK, ACK, ACK, | n_{PUCCH, 1}⁽¹⁾ | 0, 0 | 1, 0, 1, 1 |
| NACK/DTX, any | NACK/DTX | | | |
| ACK, DTX, | ACK, ACK, ACK, | n_{PUCCH, 3}⁽¹⁾ | 1, 1 | 0, 1, 1, 1 |
| DTX, DTX | NACK/DTX | | | |
| ACK, ACK, | ACK, ACK, ACK, | n_{PUCCH, 3}⁽¹⁾ | 1, 1 | 0, 1, 1, 1 |
| ACK, ACK | NACK/DTX | | | |
| NACK/DTX, any, | ACK, ACK, ACK, | n_{PUCCH, 3}⁽¹⁾ | 0, 1 | 0, 0, 1, 1 |
| any, any | NACK/DTX | | | |
| (ACK, | ACK, ACK, ACK, | n_{PUCCH, 3}⁽¹⁾ | 0, 1 | 0, 0, 1, 1 |
| NACK/DTX, any, | NACK/DTX | | | |
| any), except for | | | | |
| (ACK, DTX, | | | | |
| DTX, DTX) | | | | |
| ACK, ACK, ACK, | ACK, ACK, | n_{PUCCH, 0}⁽¹⁾ | 1, 0 | 1, 1, 1, 0 |
| NACK/DTX | NACK/DTX, any | | | |
| ACK, ACK, | ACK, ACK, | n_{PUCCH, 3}⁽¹⁾ | 1, 0 | 1, 0, 1, 0 |
| NACK/DTX, any | NACK/DTX, any | | | |
| ACK, DTX, | ACK, ACK, | n_{PUCCH, 0}⁽¹⁾ | 0, 1 | 0, 1, 1, 0 |
| DTX, DTX | NACK/DTX, any | | | |
| ACK, ACK, | ACK, ACK, | n_{PUCCH, 0}⁽¹⁾ | 0, 1 | 0, 1, 1, 0 |
| ACK, ACK | NACK/DTX, any | | | |
| NACK/DTX, any, | ACK, ACK, | n_{PUCCH, 3}⁽¹⁾ | 0, 0 | 0, 0, 1, 0 |
| any, any | NACK/DTX, any | | | |
| (ACK, | ACK, ACK, | n_{PUCCH, 3}⁽¹⁾ | 0, 0 | 0, 0, 1, 0 |
| NACK/DTX, any, | NACK/DTX, any | | | |
| any), except for | | | | |
| (ACK, DTX, | | | | |
| DTX, DTX) | | | | |
| ACK, ACK, ACK, | ACK, DTX, DTX, DTX | n_{PUCCH, 2}⁽¹⁾ | 1, 1 | 1, 1, 0, 1 |
| NACK/DTX | | | | |
| ACK, ACK, ACK, | ACK, ACK, ACK, ACK | n_{PUCCH, 2}⁽¹⁾ | 1, 1 | 1, 1, 0, 1 |
| NACK/DTX | | | | |
| ACK, ACK, | ACK, DTX, DTX, DTX | n_{PUCCH, 2}⁽¹⁾ | 0, 1 | 1, 0, 0, 1 |
| NACK/DTX, any | | | | |
| ACK, ACK, | ACK, ACK, ACK, ACK | n_{PUCCH, 2}⁽¹⁾ | 0, 1 | 1, 0, 0, 1 |
| NACK/DTX, any | | | | |
| ACK, DTX, | ACK, DTX, DTX, DTX | n_{PUCCH, 2}⁽¹⁾ | 1, 0 | 0, 1, 0, 1 |
| DTX, DTX | | | | |
| ACK, DTX, | ACK, ACK, ACK, ACK | n_{PUCCH, 2}⁽¹⁾ | 1, 0 | 0, 1, 0, 1 |
| DTX, DTX | | | | |
| ACK, ACK, | ACK, DTX, DTX, DTX | n_{PUCCH, 2}⁽¹⁾ | 1, 0 | 0, 1, 0, 1 |
| ACK, ACK | | | | |
| ACK, ACK, | ACK, ACK, ACK, ACK | n_{PUCCH, 2}⁽¹⁾ | 1, 0 | 0, 1, 0, 1 |
| ACK, ACK | | | | |
| NACK/DTX, any, | ACK, DTX, DTX, DTX | n_{PUCCH, 2}⁽¹⁾ | 0, 0 | 0, 0, 0, 1 |
| any, any | | | | |
| NACK/DTX, any, | ACK, ACK, ACK, ACK | n_{PUCCH, 2}⁽¹⁾ | 0, 0 | 0, 0, 0, 1 |
| any, any | | | | |
| (ACK, | ACK, DTX, DTX, DTX | n_{PUCCH, 2}⁽¹⁾ | 0, 0 | 0, 0, 0, 1 |
| NACK/DTX, any, | | | | |
| any), except for | | | | |
| (ACK, DTX, | | | | |
| DTX, DTX) | | | | |
| (ACK, | ACK, ACK, ACK, ACK | n_{PUCCH, 2}⁽¹⁾ | 0, 0 | 0, 0, 0, 1 |
| NACK/DTX, any, | | | | |
| any), except for | | | | |
| (ACK, DTX, | | | | |
| DTX, DTX) | | | | |
| ACK, ACK, ACK, | NACK/DTX, any, any, | n_{PUCCH, 1}⁽¹⁾ | 1, 0 | 1, 1, 0, 0 |
| NACK/DTX | any | | | |
| ACK, ACK, ACK, | (ACK, NACK/DTX, any, | n_{PUCCH, 1}⁽¹⁾ | 1, 0 | 1, 1, 0, 0 |
| NACK/DTX | any), except for (ACK, | | | |
| | DTX, DTX, DTX) | | | |
| ACK, ACK, | NACK/DTX, any, any, | n_{PUCCH, 1}⁽¹⁾ | 0, 1 | 1, 0, 0, 0 |
| NACK/DTX, any | any | | | |
| ACK, ACK, | (ACK, NACK/DTX, any, | n_{PUCCH, 1}⁽¹⁾ | 0, 1 | 1, 0, 0, 0 |
| NACK/DTX, any | any), except for (ACK, | | | |
| | DTX, DTX, DTX) | | | |
| ACK, DTX, | NACK/DTX, any, any, | n_{PUCCH, 0}⁽¹⁾ | 1, 1 | 0, 1, 0, 0 |
| DTX, DTX | any | | | |
| ACK, DTX, | (ACK, NACK/DTX, any, | n_{PUCCH, 0}⁽¹⁾ | 1, 1 | 0, 1, 0, 0 |
| DTX, DTX | any), except for (ACK, | | | |
| | DTX, DTX, DTX) | | | |
| ACK, ACK, | NACK/DTX, any, any, | n_{PUCCH, 0}⁽¹⁾ | 1, 1 | 0, 1, 0, 0 |
| ACK, ACK | any | | | |
| ACK, ACK, | (ACK, NACK/DTX, any, | n_{PUCCH, 0}⁽¹⁾ | 1, 1 | 0, 1, 0, 0 |
| ACK, ACK | any), except for (ACK, | | | |
| | DTX, DTX, DTX) | | | |
| NACK, any, any, | NACK/DTX, any, any, | n_{PUCCH, 0}⁽¹⁾ | 0, 0 | 0, 0, 0, 0 |
| any | any | | | |
| NACK, any, any, | (ACK, NACK/DTX, any, | n_{PUCCH, 0}⁽¹⁾ | 0, 0 | 0, 0, 0, 0 |
| any | any), except for (ACK, | | | |
| | DTX, DTX, DTX) | | | |
| (ACK, | NACK/DTX, any, any, | n_{PUCCH, 0}⁽¹⁾ | 0, 0 | 0, 0, 0, 0 |
| NACK/DTX, any, | any | | | |
| any), except for | | | | |
| (ACK, DTX, | | | | |
| DTX, DTX) | | | | |
| (ACK, | (ACK, NACK/DTX, any, | n_{PUCCH, 0}⁽¹⁾ | 0, 0 | 0, 0, 0, 0 |
| NACK/DTX, any, | any), except for (ACK, | | | |
| any), except for | DTX, DTX, DTX) | | | |
| (ACK, DTX, | | | | |
| DTX, DTX) | | | | |
| | | | |
|---|---|---|---|
| DTX, any, any, | NACK/DTX, any, any, | No Transmission | 0, 0, 0, 0 |
| any | any | | |
| DTX, any, any, | (ACK, NACK/DTX, any, | No Transmission | 0, 0, 0, 0 |
| any | any), except for (ACK, | | |
| | DTX, DTX, DTX) | | |
